(19) United States
(12) Patent Application Publication
(10) Pub. No.: US 2026/0134154 A1
(43) Pub. Date: May 14, 2026

(54) SYSTEMS FOR AND METHODS OF PRIVACY-PRESERVING CONTEXTUAL ATTRIBUTE EXTRACTION FROM PLAN DOCUMENTS USING MACHINE-LEARNING

(71) Applicant: Paperless Parts, Inc., Boston, MA (US)

(72) Inventors: Scott Sawyer, Auburndale, MA (US); Hank Portney, San Francisco, CA (US); Stuart Hanberg, Boston, MA (US); Luke Duros, Chicago, IL (US); Alexander Baietto, Greenwich, CT (US); Dana Wensberg, Boston, MA (US); Thomsen Cummings, Philadelphia, PA (US); Shadman Khan, Boston, MA (US)

(73) Assignee: Paperless Parts, Inc., Boston, MA (US)

(21) Appl. No.: 19/387,288

(22) Filed: Nov. 12, 2025

Related U.S. Application Data
(60) Provisional application No. 63/719,497, filed on Nov. 12, 2024.

(51) Int. Cl. G06F 21/64; G06N 20/00

(52) U.S. Cl. CPC G06F 21/64; G06N 20/00

(57) ABSTRACT

Systems for and methods of privacy-preserving metadata extraction from technical artifacts using machine-learning are disclosed. The system includes at least a processor and a memory communicatively connected to the at least a processor. The memory contains instructions configuring the at least a processor to: receive a technical artifact including textual content and graphical symbols, extract a plurality of feature instances from the technical artifact, generate, for each feature instance of the feature instances, at least one feature value, map the at least one feature value into a non-reversible feature representation, and determine, using a trained machine-learning classifier, at least one contextual attribute as a function of the non-reversible feature representation. The at least one feature value provides context to each feature instance of the plurality of feature instances.

### CROSS-REFERENCE TO RELATED APPLICATIONS

This application claims the benefit of priority of U.S. Provisional Patent Application Ser. No. 63/719,497 filed on Nov. 12, 2024 and entitled “METHOD AND SYSTEM FOR GENERATING A PRIVACY-PRESERVING ARTIFICIAL INTELLIGENCE FOR DOCUMENT UNDERSTANDING,” the entirety of which is incorporated herein by reference.

### FIELD OF THE INVENTION

The present invention generally relates to the field of artificial intelligence. In particular, the present invention is directed to systems for and methods of privacy-preserving contextual attribute extraction from plan documents using machine-learning.

### BACKGROUND

Current machine learning (ML) systems for engineering drawings struggle to accurately identify and extract essential metadata, limiting the user's ability to analyze these documents efficiently. Important metadata like part numbers, drawing numbers, titles, and revisions may be scattered beyond the title block, complicating reliable extraction, especially when additional files, such as CAD models, are inconsistently included.

### SUMMARY OF THE DISCLOSURE

In some aspects, the techniques described herein relate to a system for privacy-preserving metadata extraction from technical artifacts using machine-learning, the system including at least a processor and a memory communicatively connected to the at least a processor, wherein the memory contains instructions configuring the at least a processor to: receive a technical artifact including textual content and graphical symbols, extract a plurality of feature instances from the technical artifact, generate, for each feature instance of the feature instances, at least one feature value, wherein the at least one feature value provides context to each feature instance of the plurality of feature instances, map the at least one feature value into a non-reversible feature representation, and determine, using a trained machine-learning classifier, at least one contextual attribute as a function of the non-reversible feature representation.

In some aspects, the techniques described herein relate to a method of privacy-preserving metadata extraction from technical artifacts using machine-learning, the method including receiving, by at least a processor, a technical artifact including textual content and graphical symbols, extracting, using the at least a processor, a plurality of feature instances from the technical artifact, generating, using the at least a processor and for each feature instance of the feature instances, at least one feature value, wherein the at least one feature value provides context to each feature instance of the plurality of feature instances, mapping, using the at least a processor, the at least one feature value into a non-reversible feature representation, and determining, using the at least a processor and a trained machine-learning classifier, at least one contextual attribute as a function of the non-reversible feature representation.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a block diagram illustrating a model pre-training and inference pipeline for generating and applying non-reversible embeddings;

FIG. 1B is a block diagram of an exemplary system for privacy-preserving metadata extraction from plan documents using machine-learning;

FIG. 2 is an embodiment of a privacy-preserving artificial intelligence system for document understanding;

FIG. 3 is an embodiment of manufacturing symbols;

FIG. 4 is an embodiment of an artificial intelligence supported user interface;

FIG. 5 is an embodiment of a quote setup;

FIG. 6 is an embodiment of a part metadata setup;

FIG. 7 is a block diagram of an exemplary machine-learning module;

FIG. 8 is a diagram of an exemplary embodiment of a neural network;

FIG. 9 is a diagram of an exemplary embodiment of a node of a neural network;

FIG. 10 is a flow diagram of an exemplary method of privacy-preserving metadata extraction from plan documents using machine-learning; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Embodiments of the present invention relate to a privacy-preserving machine-learning system for extracting structured metadata from technical artifacts such as engineering drawings, blueprints, or other hybrid text-graphic documents. The system transforms document content into non-reversible feature representations through dimensionality reduction, ensuring that sensitive source information cannot be reconstructed. In an embodiment, a trained machine-learning classifier, optionally implemented as an ensemble of specialized models, infers one or more contextual attributes from these protected representations while operating in a stateless, memory-safe manner. The system may further include hallucination-mitigation and reconstruction-detection mechanisms to validate and, if necessary, remap feature embeddings that risk exposing underlying content. Verified metadata may then be standardized through a normalization layer for integration into secure downstream workflows such as quoting, compliance, or document-understanding systems.

At a high level, aspects of the present disclosure are directed to systems for and methods of generating a privacy-preserving artificial intelligence (AI) framework for document understanding. In various embodiments, the system enables the extraction and interpretation of information from technical or controlled documents while maintaining compliance with privacy and security requirements, including those governing controlled unclassified information (CUI).

Aspects of the present disclosure can be used to perform information extraction, named entity recognition, and/or object detection from technical artifacts or controlled documents in a manner that prevents reconstruction or disclosure of sensitive content. In certain embodiments, the disclosed systems and methods further facilitate drawing-level extractions for downstream workflows such as quoting, quality analysis, or compliance review.

Aspects of the present disclosure also enable AI-assisted user interaction and guidance, wherein the system provides interpretable outputs or validation feedback to support secure and efficient document processing. Exemplary embodiments illustrating aspects of the present disclosure are described below in the context of several specific examples.

Embodiments of the present invention provide a technical improvement in the field of document understanding and AI-driven metadata extraction by enabling machine-learning models to operate on non-reversible feature representations of technical artifacts, thereby preventing reconstruction or leakage of sensitive content. Unlike conventional systems that require exposure of sensitive training datasets, the disclosed system may enable pre-training and fine-tuning on sensitive or restricted documents while preserving data confidentiality. During inference, the model may operate on an input query document, which may or may not itself be sensitive, using non-reversible, dimensionally reduced embeddings that omit reconstructive components, thereby ensuring that no underlying training content can be reproduced or leaked from the model. The invention may further introduce, in some embodiments, stateless inference operations, hallucination-mitigation routines, and reconstruction-detection mechanisms that collectively reduce model bias, eliminate residual memory risks, and maintain compliance with controlled information handling standards. Through these mechanisms, the systems and methods described here within deliver accurate metadata extraction and structured document analysis while improving computational efficiency, security, and auditability in privacy-sensitive workflows

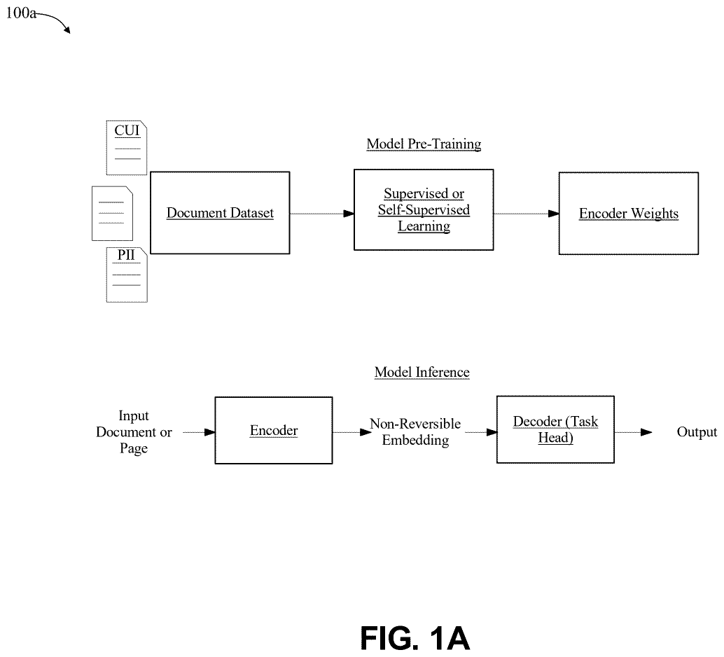

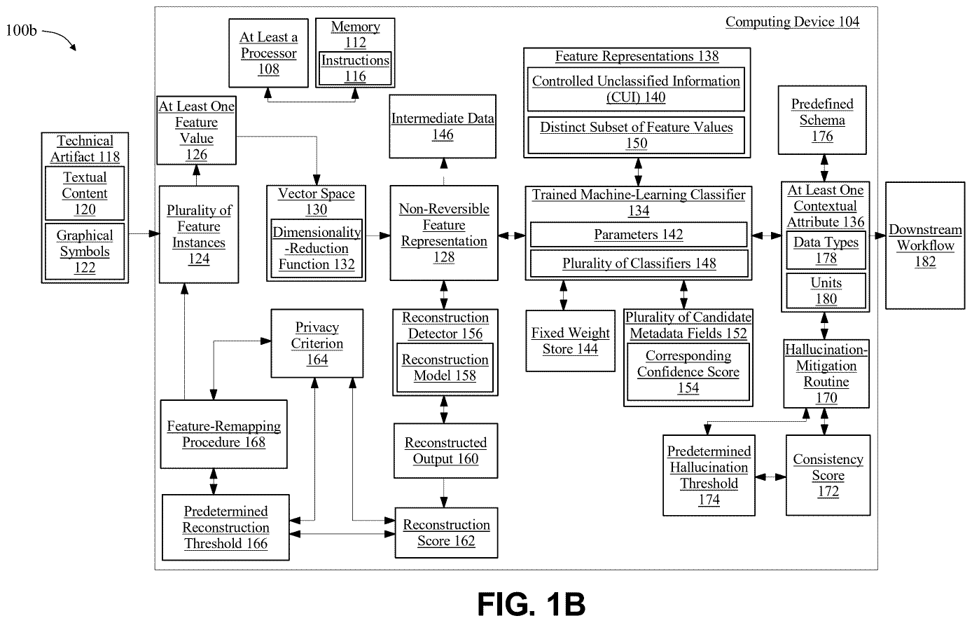

Now referring to FIG. 1A, a block diagram illustrating a model pre-training and inference pipeline 100a for generating and applying non-reversible embeddings is shown. In an embodiment, the model pre-training and inference pipeline 100a may be implemented using one or more artificial-intelligence (AI) architectures configured to generate and apply non-reversible embeddings derived from sensitive or non-sensitive document data. In one or more embodiments, the model may operate as a single-stage or multi-stage system. In one embodiment, the architecture may include a transformer model configured to accept an image as input and output a corresponding sequence of text tokens. The transformer may be pre-trained on a large dataset and a general pre-text task and subsequently fine-tuned on a smaller dataset directed to a more specific task. In other embodiments, the transformer may be trained directly on a single task. The pre-training stage may be supervised, wherein input samples are mapped to known labeled outputs, or self-supervised, wherein the model learns internal representations without human-provided ground truth. This architecture may be well-suited for applications such as optical character recognition (OCR), symbol interpretation, and/or structured information extraction from engineering drawings and technical documents.

With continued reference to FIG. 1A, in another embodiment, the model architecture may include an object-detection pipeline. In an embodiment, a first stage, or backbone, may be pre-trained on a large corpus of images and configured to produce latent embeddings that capture high-level features of the image domain. These embeddings may be non-reversible, thereby retaining contextual relationships while omitting reconstructive details of the original image. In an embodiment, the backbone may be implemented as a transformer, and the pre-training may use a self-supervised task, such as masked image modeling (MIM). In MIM, a prediction head may be trained to predict portions of an input that have been masked or redacted, enabling the backbone to develop a robust understanding of the image domain without labeled data. Once pre-training is complete, the prediction head may be replaced with a task-specific head for object detection or segmentation. In an embodiment, the subsequent stage may be trained under a supervised regime using datasets that include bounding boxes or segmentation masks identifying classes of objects within the images. Suitable second-stage architectures may include, without limitation, Detection Transformer (DETR), Cascade R-CNN, and Mask R-CNN.

Still referring to FIG. 1A, in yet another embodiment, the transformer-based and object-detection architectures may be combined into a hybrid model that first locates objects of interest on a page and then extracts or semantically interprets the text contained within those bounding regions. In some cases, the output may be structured into a representation such as XML, JSON, and/or another hierarchical schema, thereby unifying spatial, textual, and contextual information from the document into a single machine-interpretable format. In a further embodiment, the model may accept a document text layer, optionally in combination with an image input. A text layer may encode each textual unit, such as a letter, word, line, or paragraph, along with positional and stylistic attributes, including font type, weight, or size. The model may be trained to perform document classification, wherein the output corresponds to a class label for an entire page or document, or token classification, wherein the output corresponds to a class label for each token of input text. These architectures may collectively enable the system to extract, interpret, and structure complex information from technical documents while maintaining privacy preservation at the data and model levels.

In further reference to FIG. 1A, in some embodiments, the architecture described with reference to FIG. 1A may be implemented using, or in conjunction with, the system components illustrated in FIG. 1B. For instance, the encoder described in FIG. 1A may correspond to the feature-extraction or embedding-generation components of FIG. 1B, while the decoder or task head may correspond to one or more inference modules configured to derive contextual attributes, generate structured representations, or infer document-specific characteristics. In an embodiment, the pre-training and inference processes of FIG. 1A may therefore be regarded as subroutines or operational phases within the larger pipeline of FIG. 1B, in which document data, whether textual, graphical, or hybrid, is converted into non-reversible feature representations, analyzed through machine-learning classifiers, and ultimately transformed into structured outputs consumable by downstream workflows. Through this integration, the system may achieve end-to-end functionality from secure model training to privacy-preserving inference and output generation.

With continued reference to FIG. 1A, in some embodiments, the disclosed model architectures may be employed in different operational contexts or “use cases,” each emphasizing a distinct inference objective or downstream application. These use cases include, without limitation, object detection, optical character recognition (OCR) and information extraction, and named entity recognition (NER). In one embodiment, the detected objects within a document or drawing may themselves constitute the desired output, or they may serve as inputs to a subsequent stage of processing. For example, a first-stage model may detect bounding boxes corresponding to regions of interest on a page, and a second-stage model may extract the text or structured information located within those bounding boxes. In an embodiment, the detectable object classes may include common elements of engineering or manufacturing drawings, such as views (e.g., three-dimensional isometric projections, two-dimensional profiles, cross-sections, or detail views), callouts (e.g., dimensions, tolerances, geometric dimensioning and tolerancing (GD&T) feature control frames, weld symbols, holes, countersinks, counterbores, flag notes, bill-of-materials numbers and quantities, and surface finish or roughness indicators), title blocks, note lists, and borders. These classes may be chosen to provide useful contextual information to an end user or to identify which downstream processing routines, such as OCR or semantic parsing, should be applied to each region.

In further reference to FIG. 1A, in another embodiment, the system may perform OCR or structured information extraction on an entire page or on localized bounding boxes identified by the object-detection stage, a user selection, or another inference technique (for instance, a large language model). In some cases, the input image or page segment may be serialized and passed to a sequence-generation model, such as a transformer, which outputs a sequence of tokens corresponding to the recognized text. The output may represent the raw text only or may include contextual metadata describing the grouping of text into words, lines, or paragraphs and their positional and stylistic attributes (e.g., font size, boldness, or alignment). The OCR alphabet may be limited to standard characters or may be expanded to include domain-specific symbols commonly found in manufacturing drawings, such as diameter (ø), countersink (∨), or tolerance notations (+0.006/−0.001). Alternatively, the model may output structured data formatted in a markup language, such as XML or JSON, to represent the recognized elements within a formal schema. For instance, a hole callout having an asymmetric tolerance may be expressed as: <hole><multiple>2</multiple><diameter>0.500</diameter><tolerance><upper>+0.006</upper><lower>−0.001</lower></tolerance><depth>0.250</depth></hole>. This structured representation may allow downstream applications to compute tolerances, validate part geometry, or populate quality-assurance databases. Conventional OCR systems may fail to interpret such constructs correctly because the upper and lower limits are vertically displaced relative to the text baseline. Because this sequence-generation approach involves generative AI, additional post-processing may be applied to mitigate hallucination or potential leakage of training data. For example, output values may be verified by cross-checking against a secondary OCR model (such as an LSTM-based recognizer) to confirm that the extracted values exist within the original source image. Alternatively, while an upstream encoder may have been pre-trained on sensitive data, the specific OCR or structured-extraction task may be fine-tuned exclusively on synthetic or non-sensitive data to prevent leakage of controlled content.

Still referring to FIG. 1A, in another embodiment, the model may perform NER to identify textual spans that describe particular properties or contextual attributes of interest, even when exhaustive value lists are unavailable. Entities of interest may include, without limitation, part numbers, drawing numbers, revisions, descriptions, materials, finishes, general tolerances, designers, specifications (e.g., MIL-SPEC, ASTM, or ASM identifiers), and similar descriptors. The system may output these recognized entities as structured tags or as fields within a downstream data schema, enabling efficient indexing, search, and comparison of technical documents without revealing the underlying sensitive training data from which the model's domain understanding was derived.

Collectively, the model architectures and use cases described with reference to FIG. 1A operate within a privacy-preserving training and inference framework, wherein model pre-training may leverage sensitive or controlled data sources, such as datasets containing Controlled Unclassified Information (CUI) or Personally Identifiable Information (PII), to develop rich domain understanding while ensuring that no underlying training document content is ever exposed during inference. In an embodiment, the encoder component may produce non-reversible embeddings that abstract and generalize patterns from the training corpus without retaining reconstructive information. As a result, downstream inference tasks such as object detection, optical character recognition, information extraction, and/or named-entity recognition may be performed securely on new documents, including those provided by users without access to the original training data. Notably, this privacy-preserving architecture may form the underlying backbone of system 100b as described herein, such that subsequent figures and embodiments may utilize or extend the same pre-trained encoder and associated non-reversible embedding framework to enable domain-specific inference while maintaining compliance with data-sensitivity boundaries. In this manner, the disclosed system achieves the dual objectives of domain-specific model accuracy and protection of sensitive information by decoupling model utility from raw data accessibility.

Referring now to FIG. 1B, an exemplary embodiment of system 100b for privacy-preserving contextual attribute extraction from technical artifacts using machine-learning is illustrated. System 100b can also be referred to as an apparatus for privacy-preserving contextual attribute extraction from technical artifacts using machine-learning. For purposes of this disclosure, “privacy-preserving” is a configuration or operation that enables analysis or inference to occur without exposing or reconstructing sensitive or regulated content contained in the underlying data. For example, a privacy-preserving process may involve transforming document content into non-reversible feature representations 128 through dimensionality reduction or lossy embedding, thereby preventing a reverse mapping of the extracted features to the original textual or graphical information. Within system 100b, this may ensure that both the training and inference stages of the machine-learning pipeline can be performed on controlled or proprietary materials, such as engineering drawings or CUI documents, without compromising data confidentiality. For purposes of this disclosure, “metadata” is information that describes attributes, properties, or relationships of content within a technical artifact 118. For example, and without limitation, metadata may include drawing title, revision level, part number, author, material specification, and/or geometric tolerance indicators. In an embodiment, metadata may be produced by a trained classifier that interprets non-reversible feature representations 128, allowing automated identification of key document parameters without direct inspection of sensitive regions of the file.

With further reference to FIG. 1B, for purposes of this disclosure, “extraction” is the process of isolating, identifying, and formatting relevant information from a source object into a structured output form suitable for downstream use. For instance, extraction may involve parsing text tokens, vectorizing image regions, and/or detecting annotation symbols, each of which may be processed by the machine-learning subsystem to generate structured contextual attributes. Within system 100b, extraction may occur through coordinated modules that include a feature-instance generator and a classifier engine, which may operate to capture contextual relationships among textual and graphical elements. For purposes of this disclosure, a “technical artifact” is any data object that conveys engineering, design, or operational intent through a combination of text and graphical symbols. Examples include, without limitation, computer-aided design (CAD) drawings, blueprints, electrical schematics, piping and instrumentation diagrams (P&IDs), and/or other hybrid content documents. In operation, system 100b may receive a scanned drawing, vector CAD file, and/or composite PDF as input, preprocess it to detect relevant regions or features, and convert those elements into feature instances suitable for privacy-preserving analysis. In one implementation, system 100b may accomplish this process by executing a feature-extraction pipeline configured to tokenize textual regions, encode geometric primitives, and project those combined features into a non-reversible embedding space. In an embodiment, subsequent machine-learning models, such as convolutional or transformer-based classifiers, may interpret these embeddings to produce structured metadata outputs, which may be validated or normalized by downstream processing layers.

In continued reference to FIG. 1B, in an embodiment, system 100b may include circuitry, such as without limitation at least a processor 108 communicatively connected to a memory 112 containing instructions 116 configuring at least a processor 108 to initiate one or more tasks as described throughout this disclosure; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1B, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With further reference to FIG. 1B, in an embodiment, at least a processor 108 may be configured to receive a technical artifact 118 including textual content 120 and graphical symbols 122. For purposes of this disclosure, “textual content” refers to alphanumeric or symbolic information embedded within the technical artifact that conveys semantic meaning in human-readable form. Non-limiting examples of textual content 120 may include labels, part numbers, material identifiers, dimensions, revision notes, and/or specification tables that appear as text within an engineering drawing or design document. In certain embodiments, textual content 120 may be encoded as vector text within a CAD file, raster text within a scanned drawing, and/or machine-readable text obtained through optical character recognition (OCR). In an embodiment, at least a processor 108 may interpret this textual content 120 to identify metadata-bearing regions that contribute to feature generation and contextual understanding. For purposes of this disclosure, a “graphical symbol” is a non-textual visual element that represents structural, geometric, or functional aspects of the technical artifact 118. Non-limiting examples of graphical symbols 122 may include geometric primitives such as lines, arcs, and/or splines; schematic indicators such as valves, resistors, and/or flow arrows; and/or annotation markers such as leader lines and/or surface finish symbols. In an embodiment, these symbols may embody engineering intent and may be integral to the semantic meaning of the artifact. In an embodiment, graphical symbols 122 may be converted into parameterized feature instances through vectorization and/or symbol recognition models that encode geometric relationships, spatial positioning, and local connectivity.

In further reference to FIG. 1B, in an embodiment, the textual content 120 and graphical symbols 122 may form multi-modal input data that is processed by the system's feature-extraction pipeline. In an embodiment, at least a processor 108 may perform preprocessing operations such as text-region detection, segmentation of drawing layers, and/or symbol classification. The resulting unified representation may enable downstream models to learn cross-modal associations, for example, linking a textual dimension label to a corresponding geometric feature, while preserving privacy through the non-reversible feature mapping described in more detail below. In certain implementations, at least a processor 108 may use hybrid neural architectures, such as transformer-based text encoders coupled with convolutional or graph-based vision encoders, to jointly interpret textual and graphical modalities and generate context-aware feature vectors for subsequent metadata inference.

Still referring to FIG. 1B, in an embodiment, at least a processor 108 may be configured to receive the technical artifact 118 through multiple acquisition pathways, depending on system deployment or user context. In one embodiment, the technical artifact 118 may be uploaded directly by a user through an interface, which may include drag-and-drop functionality, file selection dialogs, and/or integrated scanning utilities for converting physical drawings into digital form. In another embodiment, at least a processor 108 may retrieve the technical artifact 118 from a database, content management system, or secure file repository in response to a user command, query, or automated task schedule. In an embodiment, system 100b may also receive the technical artifact 118 from an upstream processing pipeline, such as a prior workflow module responsible for image normalization, optical character recognition, or document ingestion. In such configurations, at least a processor 108 may receive the artifact as a structured data object, stream, or network payload transmitted through an application programming interface (API). Regardless of acquisition mode, at least a processor 108 may verify file integrity, authenticate the data source, and perform format normalization to ensure the received technical artifact 118 conforms to expected input standards for subsequent feature-extraction operations.

With further reference to FIG. 1B, in an embodiment, following receipt of the technical artifact 118, at least a processor 108 may be configured to perform file integrity verification, source authentication, and format normalization to ensure the received artifact conforms to predefined input standards for downstream processing. For purposes of this disclosure, “file integrity verification” is the process of confirming that the technical artifact 118 has not been corrupted, altered, or truncated during transmission or storage. In certain embodiments, this may be accomplished through the generation and comparison of cryptographic hash values (e.g., SHA-256 or MD5 checksums), verification of embedded digital signatures, and/or comparison of file size and metadata against expected specifications. For example, when a drawing file is retrieved from a secure repository, at least a processor 108 may validate that its computed hash matches the stored reference value, thereby confirming that no unauthorized modifications have occurred. For purposes of this disclosure, “authenticate the data source” refers to confirming the identity and authorization of the entity or system from which the technical artifact 118 originated. In various embodiments, source authentication may involve credential validation, API key exchange, digital certificate verification, and/or integration with an enterprise authentication framework such as OAuth 2.0 or SAML. For instance, when a user uploads a drawing through an interface, system 100b may authenticate the user's credentials and record the event in an access log; when the file is retrieved from a database, at least a processor 108 may authenticate the connection to the database service and validate that the file originates from an approved domain or repository. This authentication step may ensure that only trusted artifacts are introduced into the privacy-preserving pipeline, mitigating the risk of data contamination or unauthorized access.

With continued reference to FIG. 1B, for purposes of this disclosure, “format normalization” is the process of converting heterogeneous technical artifact 118 formats into a standardized input representation suitable for downstream feature-extraction operations. Because engineering and technical documents may exist in diverse formats, including raster images (e.g., TIFF, PNG), vector-based CAD files (e.g., DWG, DXF), hybrid documents (e.g., PDF), or structured markup (e.g., XML, SVG), at least a processor 108 may execute one or more normalization routines to unify their structure and coordinate systems. In some embodiments, this may include converting images to a consistent resolution, aligning vector coordinate frames, or flattening multi-layer CAD structures into a standardized schema. The system may also normalize text encodings (e.g., UTF-8), enforce consistent unit conventions, and ensure that all geometric primitives adhere to a defined precision threshold.

In further reference to FIG. 1B, in an embodiment, the integrity verification, source authentication, and format normalization stages may be implemented as a preprocessing module within the system's data-ingestion pipeline. In an embodiment, this module may operate asynchronously to verify and sanitize input files prior to the initiation of the feature-instance extraction process. By enforcing these validation steps, system 100b may ensure that only authentic, intact, and structurally consistent artifacts enter the privacy-preserving workflow, thereby enhancing reliability, traceability, and downstream model performance.

Still referring to FIG. 1B, in an embodiment, system 100b may include a preprocessing module configured to manage the intake, verification, and preparation of technical artifacts 118 prior to feature-instance extraction. In an embodiment, the preprocessing module may operate under the control of at least a processor 108 and memory 112 and may execute a coordinated sequence of operations to ensure that all received artifacts are authentic, intact, and compatible with the system's privacy-preserving data pipeline. As described above, these operations can include file integrity verification, data source authentication, and format normalization, each designed to confirm that the technical artifact 118 meets defined security and formatting criteria before downstream analysis begins. In some implementations, the preprocessing module may include an ingestion interface that receives technical artifacts 118 through secure transmission channels such as HTTPS, SFTP, or an authenticated application programming interface (API). Upon receipt, the module may initiate integrity checks by generating cryptographic hashes or validating digital signatures to confirm that no unauthorized alteration has occurred. In parallel, the module may perform data-source authentication through credential verification, token validation, or digital certificate inspection to confirm the trustworthiness of the sender or upstream system.

In continued reference to FIG. 1B, in an embodiment, following successful verification and authentication, the preprocessing module may execute format normalization routines that reconcile structural and encoding differences across heterogeneous input types. These routines may, for example, flatten layered vector drawings, convert image-based artifacts to standardized resolutions, or align coordinate systems between differing CAD or hybrid document formats. Additional operations may include unit harmonization, text encoding conversion, or removal of nonessential embedded objects to ensure consistent data structure. In an embodiment, the preprocessing module may also maintain transactional logs and validation records that document the completion of each verification and normalization step. These records may include time stamps, hash values, and source identifiers, providing a traceable audit trail that supports both operational monitoring and compliance with controlled data-handling requirements. In an embodiment, once preprocessing is complete, the verified and normalized artifact may be passed to the next stage of the pipeline, where system 100b may begin extracting feature instances and generating feature values as part of the privacy-preserving metadata extraction process.

In continued reference to FIG. 1B, in an embodiment, at least a processor 108 may be configured to extract a plurality of feature instances 124 from the technical artifact 118. For purposes of this disclosure, a “feature instance” is a discrete representation of a detectable element within the technical artifact 118 that carries structural, textual, or contextual significance. In an embodiment, each feature instance of the plurality of feature instances 124 may correspond to a word, symbol, line segment, annotation, and/or other identifiable component and may be characterized by a set of associated feature values such as spatial coordinates, size, orientation, font type, or relational proximity to other elements. Collectively, these feature instances form the fundamental data units used by the system's machine-learning models to perform privacy-preserving metadata extraction and classification.

With further reference to FIG. 1B, in an embodiment, the plurality of feature instances 124 may be derived from one or more of raster-based and vector-based representations of the technical artifact 118. For purposes of this disclosure, “raster” refers to pixel-based image data. For example, such as scanned blueprints, diagrams, and/or hybrid PDF files that encode text and graphics as pixel arrays. In an embodiment, to interpret raster data, at least a processor 108 may apply optical character recognition (OCR) algorithms to detect, segment, and convert textual regions into machine-readable tokens, each of which may become an individual feature instance linked to positional and stylistic information extracted from the image. For example, an OCR module may detect the text “Material: Steel A36” within a scanned drawing, convert it to encoded text, and associate it with a bounding box coordinate, font size, and local region confidence score. In contrast, vector-based representations, such as those found in computer-aided design (CAD) files or vectorized PDFs, may encode text, geometry, and symbols through mathematical primitives (e.g., lines, arcs, polylines, and splines) and coordinate-based relationships. In an embodiment, at least a processor 108 may parse these primitives to construct feature instances that describe both the geometric form and semantic meaning of elements within the drawing. For example, a circular vector primitive may be recognized as a hole feature, and a connected set of polylines and annotations may be identified as a component boundary with associated dimensional data.

Still referring to FIG. 1B, in an embodiment, at least a processor 108 may also perform hybrid feature extraction, combining OCR-based textual instances from raster layers with symbol and geometry instances from vector layers to produce a unified, multi-modal feature dataset. During this process, system 100b may assign linkage metadata between textual and graphical features, such as associating a dimensional label with a corresponding line segment or connecting a material note to a specific component region. In an embodiment, these linkages may preserve contextual relationships and improve downstream metadata inference accuracy. In an embodiment, implementation of feature-instance extraction may utilize a combination of rule-based and machine-learning-based methods. In some cases, rule-based algorithms may identify known patterns (e.g., title blocks, revision tables, or layer names), while machine-learning components, such as convolutional neural networks (CNNs), vision transformers, and/or graph neural networks, may infer higher-order relationships between elements. In some embodiments, extracted feature instances and their corresponding feature values may be encoded into structured data objects for subsequent transformation into the non-reversible feature representations 128 described in later sections.

With continued reference to FIG. 1B, in certain embodiments, system 100b may employ rule-based algorithms to identify and classify common elements within the technical artifact 118 based on predefined structural, textual, or geometric patterns. For example, a rule set may specify that any text appearing within a title-block boundary and preceded by the term “DRAWING NO.” should be classified as a part identifier, or that a closed rectangular region in the lower-right corner of a drawing corresponds to a signature field. In an embodiment, these rules may be expressed as if then logic statements, regular expressions, or geometric constraints that define expected relationships between textual and graphical features. In an embodiment, rule-based extraction rules may be generated during system configuration or learned semi-automatically through observation of annotated examples. In some embodiments, a domain expert may define the initial rule set by reviewing representative samples of drawings, schematics, and/or blueprints and encoding known structural conventions. Over time, system 100b may automatically refine or extend these rules using statistical pattern mining or feedback derived from verified outputs. For instance, if a rule consistently fails to identify a certain layout pattern in new document types, system 100b may prompt for user confirmation or dynamically generate a supplemental rule based on recurrent spatial or lexical correlations. In an embodiment, the rule-based algorithms may therefore operate as a first-pass extraction layer, efficiently identifying standardized elements, reducing computational load on downstream models, and providing high-confidence contextual anchors for machine-learning classifiers.

In further reference to FIG. 1B, in an embodiment, in addition to or in combination with rule-based extraction, system 100b may include one or more machine-learning models trained to detect, classify, and contextualize feature instances across a diverse range of technical artifact 118 formats. In an embodiment, these models may include convolutional neural networks (CNNs) for image-based detection, transformer-based encoders for textual or hybrid modalities, and/or graph neural networks (GNNs) for learning relational structures among features. In some cases, the models may be trained on curated datasets including, but not limited to, labeled technical artifacts 118, each containing corresponding annotations that identify textual content 120, graphical symbols 122, component boundaries, and/or metadata fields. In an embodiment, training data may originate from public engineering drawing datasets, synthetically generated schematics, and/or proprietary collections of anonymized CUI-compliant documents.

With further reference to FIG. 1B, in an embodiment, training may involve minimizing a loss function that penalizes misclassification of features or incorrect spatial associations between textual and graphical elements. During training, system 100b may apply data augmentation techniques, such as rotation, scaling, occlusion, and noise injection, to increase model robustness to variations in format and image quality. In some embodiments, the training data may undergo privacy filtering or differential-noise injection prior to use, ensuring that no identifiable or reconstructive information from sensitive documents is retained in model weights. In an embodiment, the trained models may be periodically retrained or fine-tuned as new artifacts are processed, enabling system 100b to adapt to new drawing standards, document templates, and/or emerging symbol conventions. Retraining may, in some instances, occur automatically when model confidence metrics or reconstruction detection scores indicate drift or underperformance. In an embodiment, system 100b may maintain a versioned model repository, wherein each training event is logged with model parameters, dataset identifiers, and/or performance metrics, allowing for traceability and rollback to prior configurations. This adaptive training framework may ensure that the machine-learning components continuously improve extraction accuracy while maintaining privacy-preserving guarantees established by the non-reversible feature transformation layer.

In continued reference to FIG. 1B, in one exemplary hybrid implementation, system 100b may receive an engineering drawing representing a component assembly that includes both raster and vector elements. A user may upload the artifact as a hybrid PDF file containing scanned image data and embedded CAD geometry. Upon receipt, the preprocessing module may perform file-integrity verification using hash comparison, authenticate the user's session credentials, and normalize the file into a standardized internal format. During normalization, the module may flatten vector layers, convert embedded raster images to grayscale, align coordinate systems, and harmonize measurement units. The verified and normalized artifact may then be transferred to the feature-extraction pipeline for multi-modal analysis. Within the pipeline, the raster portion of the technical artifact 118, comprising text labels, dimension notes, and/or image-based annotations, may be processed using optical character recognition (OCR) to identify individual words and numeric strings. In an embodiment, each recognized text region may be converted into a feature instance with associated feature values that include bounding-box coordinates, confidence scores, font characteristics, and extracted text content. Concurrently, the vector portion of the technical artifact 118, comprising lines, circles, arcs, and polylines representing the component geometry, may be parsed using vector-encoding routines that convert geometric primitives into parametric representations. In an embodiment, these representations may include start and end coordinates, radius values, line weights, and adjacency relationships, each forming additional feature instances.

Still referring to FIG. 1B, in an embodiment, after independent extraction, a fusion stage may align textual and geometric features to form contextual linkages. For example, a dimension value identified through OCR may be associated with the corresponding line segment defining that dimension, and a material specification note may be linked to the geometric boundary of the component it describes. In some cases, a rule-based engine may enforce known layout conventions (e.g., title-block positioning, revision-table structure), while a machine-learning classifier may simultaneously evaluate spatial and semantic relationships among the features to identify higher-order entities such as “component label,” “weld callout,” and/or “inspection note.” The outputs of both engines may be combined into a unified feature-instance dataset, where each instance is tagged with contextual metadata and prepared for conversion into the non-reversible feature representation 128. In some embodiments, the hybrid system may operate in a streaming mode, enabling real-time extraction as large files are uploaded or scanned. This may allow at least a processor 108 to continuously populate the feature-instance dataset, providing immediate feedback to downstream modules such as the reconstruction detector 156, hallucination-mitigation routine 170, and/or output-normalization layer. In an embodiment, the result is an integrated, privacy-preserving document-understanding framework capable of processing complex, mixed-format technical artifacts 118 without exposing the underlying sensitive content.

Still referring to FIG. 1B, in an embodiment, at least a processor 108 may be configured to generate, for each feature instance of the feature instances, at least one feature value 126. For purposes of this disclosure, a “feature value” is a measurable or descriptive attribute associated with a feature instance that quantitatively or qualitatively characterizes its properties. In an embodiment, each feature instance of the plurality of feature instances 124 may have one or more feature values, which may include, without limitation geometric, textual, positional, and/or relational parameters derived from the technical artifact 118. For example, a textual feature instance representing the note “Material: Steel A36” may have feature values corresponding to text content, font size, bounding-box coordinates, orientation, and/or extraction confidence. Similarly, a geometric feature instance corresponding to a circular hole may have feature values representing its radius, centroid position, boundary precision, and adjacency to other geometric features. In an embodiment, the at least one feature value 126 may provide context to each feature instance of the plurality of feature instances 124. For purposes of this disclosure, “context” refers to the informational relationship between a given feature instance and other elements or regions of the technical artifact 118. For example, including spatial, semantic, and/or hierarchical associations. In an embodiment, context may enable system 100b to interpret a feature instance not merely as an isolated object but as part of a structured, meaningful configuration. For example, a numerical string such as “Ø10.0” may acquire contextual meaning as a hole diameter dimension when it is positioned adjacent to a circular feature instance, or a text element reading “REV B” may be interpreted as a revision indicator when located within a title-block region. In an embodiment, the at least one feature value 126 therefore may provide both intrinsic detail about a feature instance and extrinsic relationships that define how that feature contributes to the overall understanding of the technical artifact 118.

In further reference to FIG. 1B, in an embodiment, at least a processor 108 may compute feature values through a combination of analytic measurements and learned model inference. In an embodiment, analytic measurements may include calculating distances, angles, and/or spatial relationships between vector primitives, while learned inferences may involve embedding textual or symbolic data into a vector space 130 using natural language processing (NLP) or vision-encoding models. In some embodiments, system 100b may generate additional derived feature values, such as normalized coordinates, local density scores, and/or semantic embeddings, to capture higher-order relationships between features. These contextualized feature values may be stored in structured data objects that represent the intermediate state of the technical artifact 118 prior to privacy-preserving transformation. In certain implementations, at least a processor 108 may further evaluate confidence metrics for each feature value to quantify extraction reliability. Confidence may be computed as a function of OCR probability scores, geometric fit residuals, and/or classification logits generated by a trained model. In an embodiment, the inclusion of confidence and relational metrics as feature values may allow downstream modules, such as the hallucination-mitigation routine 170 or reconstruction detector 156, to weigh or adjust metadata inference outcomes based on data quality and contextual certainty.

In further reference to FIG. 1B, in some embodiments, system 100b may employ natural language processing (NLP) techniques to interpret and embed textual content 120 or symbolic annotations within the technical artifact 118. The NLP framework may convert words, abbreviations, and domain-specific terms into numerical vector representations that capture semantic similarity and contextual meaning. In some cases, the NLP framework may include a language processing module. Language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 1B, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to FIG. 1B, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Alternatively, or additionally, and with continued reference to FIG. 1B, language processing module may be produced using one or more large language models (LLMs). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, medical report documents, electronic health records, entity documents, business documents, inventory documentation, emails, user communications, advertising documents, newspaper articles, and the like. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 1B, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters 142 of the one or more models (weights and biases) either randomly or using a pretrained model. Generally training one or more machine learning models on a large corpus of text data can provide a starting point for fine-tuning on a specific task. A model such as an LLM may learn by adjusting its parameters 142 during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 1B, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. Within the context of the present disclosure, an LLM may be configured to receive textual content 120 extracted from a technical artifact 118 and generate a contextual embedding vector that captures the probable semantic meaning of each token or phrase without reconstructing the underlying document. For example, when processing the text sequence “Material: Stainless,” the model may assign high contextual relevance to potential continuations such as “Steel” or “304,” based on learned co-occurrence probabilities from domain-specific corpora. Unlike conventional generative use cases, the implementation described herein leverages the model's encoder and decoder components primarily for embedding and contextual inference, rather than for open-ended text generation. In this configuration, the LLM outputs dense numerical vectors that encode linguistic relationships and domain context, which are subsequently incorporated into the system's feature-value dataset and mapped into the non-reversible feature space for downstream privacy-preserving metadata extraction.

Still referring to FIG. 1B, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1B, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 1B, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1B, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 1B, in some embodiments, the language-processing model may employ a multi-headed attention mechanism within its encoder to compute contextual relationships among tokens extracted from the technical artifact 118. The attention mechanism, specifically, self-attention, may enable the model to evaluate how each token or symbol relates to every other token within the same sequence, thereby capturing dependencies and semantic context across a document or drawing. For example, the model may learn to associate the token “MATERIAL” with the nearby token “ALUMINUM,” or the token “REV” with “B,” recognizing that such pairings convey domain-specific meaning within an engineering drawing. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 1B, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1B, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 1B, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 1B, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1B, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 1B, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1B, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 1B, decoder may take this output and add it to the decoder inputs. Decoder may continue decoding until a token is predicted. Decoder may stop decoding once it predicts an end token.

Continuing to refer to FIG. 1B, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 1B, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data associated with a technical artifact 118 such as an engineering drawing containing labels, revision notes, and material specifications extracted through preprocessing and optical character recognition (OCR).

With continued reference to FIG. 1B, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

Continuing to refer to FIG. 1B, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1B, language processing module may use a corpus of documents to generate associations between language elements in a language processing module, and diagnostic engine may then use such associations to analyze words extracted from one or more documents and determine that the one or more documents indicate significance of a category. In an embodiment, language module and/or computing device 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into computing device 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

In further reference to FIG. 1B, in an embodiment, complementary to the language-based embeddings, system 100b may employ one or more vision-encoding models to process graphical and geometric components of the technical artifact 118. In an embodiment, a vision-encoding model may include a neural network or computational architecture trained to transform image- or vector-based inputs into compact numerical embeddings that preserve visual and spatial relationships while omitting reconstructive information. In certain embodiments, at least a processor 108 may implement a convolutional neural network (CNN) or vision transformer (ViT) trained on labeled engineering drawings, schematics, and component diagrams to identify characteristic features such as geometric primitives, symbols, and layout patterns. In an embodiment, the vision-encoding model may receive rasterized patches, vector primitives, and/or symbolic masks as input and output multi-dimensional feature embeddings that describe edges, contours, and spatial hierarchies among objects. During training, the model may learn to associate visual motifs, such as standard schematic icons, dimensioning conventions, or weld symbols, with latent feature vectors that capture their semantic role in the artifact. In some implementations, a graph neural network (GNN) may be integrated with the vision encoder to explicitly represent relational dependencies between graphical elements (for example, connecting a leader line to its corresponding text label or associating a dimension arrow with its measured feature). The resulting visual embeddings may be concatenated or fused with text-derived embeddings to produce a unified contextual representation, which system 100b subsequently maps into the non-reversible feature space. In an embodiment, because the vision-encoding model may operate on geometric and symbolic cues rather than pixel-level reconstruction, the derived embeddings may retain functional meaning while inherently preserving privacy by eliminating reconstructive detail.

In continued reference to FIG. 1B, in an embodiment, system 100b may include a fusion stage configured to combine embeddings generated by the language-processing and vision-encoding components into a unified contextual representation of the technical artifact 118. In an embodiment, the fusion stage may operate by aligning text-derived embeddings, which capture semantic meaning of labels and annotations, with vision-derived embeddings, which encode geometric and symbolic structure. Alignment may occur through a cross-attention mechanism or feature-matching network that learns correspondence between textual tokens and graphical features occupying related spatial or semantic regions within the artifact. For example, system 100b may associate the token embedding for “Ø10.0” from the language model with a circular vector primitive identified by the vision encoder, thereby producing a composite feature representation that captures both the numerical value and its geometric referent. In an embodiment, the fusion stage may further normalize embedding dimensions, concatenate or sum aligned vectors, and apply weighting functions that balance linguistic and visual confidence scores. In some embodiments, a graph-based fusion layer may represent the technical artifact 118 as a heterogeneous graph, where nodes correspond to textual and graphical feature instances and edges encode learned contextual relationships. Further, in an embodiment, at least a processor 108 may update node representations through iterative message-passing or attention-based aggregation to generate a context-rich feature set describing the artifact in unified form. In an embodiment, this fused representation may preserve cross-modal context necessary for accurate metadata inference while abstracting away redundant and/or format-specific details. The output of the fusion stage thus may serve as the final intermediate embedding layer that feeds into the downstream privacy-preserving transformation module, where dimensionality reduction and information-loss constraints are applied to generate the non-reversible feature representation 128 described in subsequent sections.

With continued reference to FIG. 1B, in an embodiment, the at least a processor 108 may be configured to map the at least one feature value 126 into a non-reversible feature representation 128. In an embodiment, each feature value may correspond to textual, geometric, and/or relational data that describes how an element appears or behaves within the document. Non-limiting examples may include bounding-box coordinates of a text region, a numeric dimension value, a symbol classification label, and/or a learned embedding derived from a language-processing or vision-encoding model. For purposes of this disclosure, a “non-reversible feature representation” refers to a transformed data structure or embedding that encodes these feature values into a mathematical space such that the original document content cannot be reconstructed. In this representation, information necessary for accurate inference may be retained, while reconstructive components, such as text strings, pixel patterns, or geometric relationships sufficient to reproduce the source image, are deliberately removed or compressed beyond recoverability. In an embodiment, the resulting non-reversible feature representation 128 may serve as a privacy-preserving intermediary, enabling downstream machine-learning classifiers to analyze contextual meaning without ever accessing or regenerating sensitive document content.

In continued reference to FIG. 1B, in an embodiment, this mapping process may provide a significant technical advantage over conventional document-understanding systems. Whereas traditional pipelines may operate directly on OCR text or vector geometry that can be reverse engineered to reveal controlled unclassified information (CUI) 140 or proprietary design data, the disclosed mapping stage may ensure that downstream inference occurs exclusively on non-reversible, de-identified feature embeddings. This architecture may establish a computational firewall between semantic analysis and reconstructive data, enabling secure machine-learning inference under privacy, export-control, and/or data-handling constraints.

With further reference to FIG. 1B, in an embodiment mapping the at least one feature value 126 into the non-reversible feature representation 128 may include embedding the at least one feature value 126 into a vector space 130 constrained by a dimensionality-reduction function 132. For purposes of this disclosure, a “vector space” is a multi-dimensional numerical domain in which each axis represents a quantitative or latent attribute of the feature values derived from the technical artifact 118. In an embodiment, within the vector space 130, each feature instance may be represented as a point or vector whose coordinates encode semantic, geometric, and/or relational information learned by the system's language-processing or vision-encoding models. For example, textual features describing material specifications and graphical features depicting component geometry may occupy nearby regions in the vector space 130 if they are semantically and/or functionally related. For purposes of this disclosure, a “dimensionality-reduction function” is a mathematical or learned transformation that projects high-dimensional feature vectors into a lower-dimensional subspace while preserving information relevant for downstream inference. In an embodiment, the dimensionality-reduction function 132 may be implemented using principal-component analysis (PCA), random projection, autoencoder bottlenecks, and/or learned manifold compression layers trained to minimize information loss for metadata-related tasks. By reducing the number of dimensions, system 100b may eliminate redundant or highly correlated attributes and compress the feature data into a compact, privacy-preserving embedding that retains discriminative value but lacks sufficient detail for reconstruction.

Still referring to FIG. 1B, in an embodiment, the dimensionality-reduction function 132 may omit one or more reconstructive components of the textual content 120 and graphical symbols 122 of the technical artifact 118. For purposes of this disclosure, a “reconstructive component” is any portion of the feature data that could enable regeneration of the original textual or graphical content of the technical artifact 118. In an embodiment, reconstructive components may include, without limitation, pixel intensities, glyph outlines, geometric coordinates with absolute precision, and/or positional relationships that, if preserved, would permit re-creation of document imagery or design geometry. In the present embodiment, the dimensionality-reduction function 132 may be configured to omit or obfuscate such reconstructive components, through lossy projection, stochastic perturbation, or irreversible quantization, thereby preventing reverse engineering of the source material. In an embodiment, at least a processor 108 may apply the dimensionality-reduction function 132 to all aggregated feature vectors produced by the fusion stage, generating a non-reversible embedding matrix that serves as the system's core privacy-preserving data representation. This transformation may maintain relational patterns necessary for accurate metadata inference while ensuring that no deterministic mapping exists between the reduced embedding and the original artifact. Consequently, downstream classifiers may perform prediction, validation, and/or scoring exclusively within this non-reversible feature space, thereby providing both computational efficiency and strong privacy guarantees.

Still referring to FIG. 1B, in an embodiment, at least a processor 108 may be configured to evaluate the non-reversible feature representation 128 using a reconstruction detector 156. For purposes of this disclosure, a “reconstruction detector” is a validation component, model, or ensemble of algorithms configured to determine whether a given feature representation retains sufficient reconstructive information to permit recovery of the original technical artifact 118. In an embodiment, the reconstruction detector 156 may serve as a privacy assurance module, ensuring that the transformation from the original feature values to the non-reversible feature representation 128 satisfies an information-loss threshold required for compliance with data-handling or export-control standards. In some embodiments, the reconstruction detector 156 may be implemented as a trained neural network, an autoencoder pair, or a contrastive evaluation routine that attempts to regenerate text and geometry from the privacy-preserving embeddings.

In continued reference to FIG. 1B, in an embodiment, the reconstruction detector 156 may be trained or retrained using datasets including pairs of original technical artifacts 118 and their corresponding non-reversible feature representations 128. In an embodiment, the training process may be configured to estimate the degree of reconstructive fidelity achievable from privacy-preserving embeddings. For implementations using a neural network, the reconstruction detector 156 may be trained in a supervised fashion to predict a reconstruction probability or similarity score between the regenerated output and the original artifact. Ground-truth labels may represent reconstruction success metrics, such as cosine similarity between embeddings, structural similarity index (SSIM) between images, and/or edit distance between recovered and source text. In embodiments where the reconstruction detector 156 is realized as an autoencoder pair, training may involve two coupled networks: an encoder that attempts to compress the non-reversible feature representation 128 and a decoder that attempts to reconstruct the original artifact. In an embodiment, during training, the decoder's reconstruction error (e.g., pixel-wise mean-squared error, text perplexity, or hybrid multimodal loss) may be minimized to approximate the potential reversibility of the embedding. In some cases, a separate evaluator network or statistical module may then learn to interpret the magnitude of this error as a privacy risk score, which may become the reconstruction score 162 computed during runtime. Alternatively, in contrastive evaluation routines, the reconstruction detector 156 may be trained using positive and negative sample pairs. In an embodiment, positive pairs may include non-reversible embeddings intentionally derived from lightly obfuscated data, while negative pairs include embeddings subjected to stronger privacy constraints. The contrastive loss function (e.g., InfoNCE or triplet loss) may encourage the detector to differentiate between embeddings that retain reconstructive detail and those that do not. Over time, the detector may learn a feature-space boundary separating “reconstructable” from “non-reconstructable” representations. In an embodiment, retraining of the reconstruction detector 156 may occur periodically or automatically when new data types 178, document formats, or privacy requirements are introduced. In some embodiments, the detector may engage in continual learning, wherein new examples of technical artifacts 118, such as architectural plans, mechanical drawings, and/or text-based specifications, are incrementally integrated into the training dataset. This may allow the detector to adapt to evolving model architectures, maintain calibration of reconstruction thresholds, and ensure persistent enforcement of privacy guarantees throughout system operation.

With further reference to FIG. 1B, in some cases, the detector may assess how effectively a downstream model, or a potential adversarial model, could approximate the original input from the reduced feature set. In doing so, the reconstruction detector 156 may provide a quantitative measure of the representation's irreversibility. In an embodiment, at least a processor 108 may employ this detector either during model training, as part of a periodic validation routine, or dynamically during inference to ensure that no privacy degradation occurs as models or feature mappings evolve over time. In an embodiment, the reconstruction detector 156 thus may act as a safety checkpoint between the embedding and inference stages, enabling system 100b to monitor and enforce privacy-preserving behavior automatically. By continuously evaluating reconstruction potential, system 100b may guarantee that downstream metadata extraction and classification are performed only on de-identified, non-reconstructive data, thereby maintaining strong compliance and confidentiality assurances across diverse technical artifact types.

In continued reference to FIG. 1B, in an embodiment, evaluating the non-reversible feature representation 128 may include generating, using a reconstruction model 158, a reconstructed output 160 corresponding to one or more of the textual content 120 and the graphical symbols 122 of the technical artifact 118. For purposes of this disclosure, a “reconstruction model” is a computational model, neural architecture, or algorithmic framework configured to approximate or regenerate the source content of a technical artifact 118 from its privacy-preserving feature representation. In an embodiment, the reconstruction model 158 may be implemented as a decoder network, an inverse-mapping autoencoder, and/or a generative diffusion or transformer model trained to predict the most probable original features given an input embedding. In certain embodiments, the reconstruction model 158 may mirror the structure of the encoder or fusion modules used in feature extraction, thereby allowing it to estimate how much semantic or structural information remains latent within the non-reversible representation. For purposes of this disclosure, a “reconstructed output” is any data structure, image, or text string generated by the reconstruction model 158 that represents a hypothesized approximation of the original technical artifact 118. Depending on the modality of the input, the reconstructed output 160 may include one or more of: a rasterized image simulating the original drawing layout; a sequence of text tokens approximating extracted annotations; and/or a hybrid symbolic-geometric structure depicting probable relationships between textual and graphical elements. For example, when the reconstruction model 158 receives a non-reversible embedding corresponding to a mechanical drawing, the reconstructed output 160 may include blurred outlines of geometric shapes and partial material labels derived from residual correlations in the embedding.

With continued reference to FIG. 1B, in an embodiment, the reconstruction model 158 may be executed under controlled evaluation conditions in which at least a processor 108 limits runtime memory access and disables caching of intermediate results, thereby ensuring that the reconstruction process itself does not compromise privacy. In an embodiment, by attempting to recreate text or geometry from the non-reversible feature representation 128, the reconstruction model 158 may provide a measurable estimate of reconstruction potential, serving as the first step in computing a reconstruction score 162 that quantifies residual reversibility. The reconstructed output 160 generated in this process may not be used for downstream inference or output presentation but may be used solely for privacy verification within the reconstruction-detector pipeline.

Still referring to FIG. 1B, in some embodiments, the reconstruction model 158 may be trained or retrained using paired datasets including original technical artifacts 118 and corresponding non-reversible feature representations 128 generated by the system's embedding and dimensionality-reduction pipeline. In an embodiment, training may be conducted under a supervised or self-supervised paradigm, wherein the reconstruction model 158 learns to approximate original text, imagery, or geometric structure from the reduced embeddings. The objective of such training is not to enable faithful regeneration of source content, but rather to quantify residual reconstructive potential that remains after privacy transformation. In this context, the reconstruction model 158 may function as a diagnostic adversary, a model that tries, but intentionally fails, to recreate the input data beyond a predetermined privacy threshold. In an embodiment, training data for the reconstruction model 158 may include diverse technical artifacts 118 representing multiple document modalities and formats, such as computer-aided design (CAD) drawings, engineering blueprints, architectural plans, scanned schematics, and/or text-based technical specifications. For each technical artifact 118, the corresponding non-reversible feature representation 128 may serve as the model input, while the original raster or textual form serves as the target output. In an embodiment, the reconstruction model 158 may minimize one or more reconstruction losses, such as mean-squared error (MSE) for imagery, cross-entropy loss for textual sequences, and/or structural similarity index (SSIM) for mixed-modality features, to learn correlations between de-identified embeddings and source data. In certain embodiments, the reconstruction model 158 may employ a multimodal decoder architecture with distinct output branches for text and geometry, trained concurrently under a composite loss function that balances linguistic and visual fidelity metrics. In an embodiment, during training, at least a processor 108 may monitor both the model's reconstruction accuracy and the system's privacy objective, adjusting the parameters 142 of the dimensionality-reduction module or noise layers if the reconstruction model 158 demonstrates excessive fidelity. Further, in an embodiment, retraining may occur periodically or automatically in response to updates in the embedding architecture, data modality, and/or privacy regulations. For example, when new types of documents or symbol sets are introduced, the reconstruction model 158 may be retrained using a transfer-learning protocol, fine-tuning its decoder layers to adapt to updated privacy-preserving embedding formats while maintaining compliance with the established reconstruction threshold.

With further reference to FIG. 1B, in an embodiment, evaluating the non-reversible feature representation 128 may include computing a reconstruction score 162 as a function of comparing the reconstructed output 160 to the technical artifact 118. For purposes of this disclosure, a “reconstruction score” is a quantitative metric representing the degree of similarity between the reconstructed output 160 and the original technical artifact 118 prior to privacy transformation. In an embodiment, the reconstruction score 162 may provide a normalized measure of residual reconstructive fidelity, quantifying how much semantic, visual, and/or geometric information remains recoverable from the non-reversible feature representation 128. In some embodiments, the reconstruction score 162 may be computed using one or more similarity or distance metrics depending on the modality of the data. In an embodiment, for visual or graphical artifacts, at least a processor 108 may compute a pixel- or structure-based similarity, such as a structural similarity index (SSIM), mean-squared error (MSE), peak signal-to-noise ratio (PSNR), and/or feature-map correlation between the reconstructed and source images. In an embodiment, for textual or symbolic content, the reconstruction score 162 may include metrics such as cosine similarity between embedding vectors, Levenshtein edit distance, and/or perplexity based on token probabilities. Hybrid representations, such as CAD drawings containing both text annotations and geometric entities, may be evaluated using a weighted composite score that integrates visual and linguistic similarity components according to a configurable weighting scheme. In an embodiment, the reconstruction score 162 may be computed on a normalized scale, for example between 0 and 1, where higher values indicate greater reconstructive similarity and lower values indicate stronger privacy preservation. In some embodiments, system 100b may maintain a privacy threshold defining the maximum permissible reconstruction score 162 that still satisfies compliance with data-handling or export-control requirements. In an embodiment, at least a processor 108 may periodically recompute reconstruction scores 162 during training, inference, or audit cycles to monitor the ongoing integrity of the non-reversible feature representation 128. By quantifying the residual reconstructive potential of the feature space, the reconstruction score 162 may provide a continuous and model-agnostic metric for privacy assurance, allowing system 100b to automatically adjust, retrain, or reject models that exceed allowable reconstruction limits.

Still referring to FIG. 1B, in an embodiment, evaluating the non-reversible feature representation 128 may include determining satisfaction of a privacy criterion 164 as a function of the reconstruction score 162 and a predetermined reconstruction threshold 166. For purposes of this disclosure, a “privacy criterion” is a defined condition or set of quantitative rules specifying the allowable extent to which a non-reversible feature representation 128 retains reconstructive similarity to its originating technical artifact 118. In an embodiment, the privacy criterion 164 may act as a system-level safeguard that ensures compliance with confidentiality, regulatory, and/or export-control standards governing the processing of controlled technical data. In some embodiments, the privacy criterion 164 may be satisfied when the reconstruction score 162 computed for a given feature representation falls below an established numerical limit, indicating that the corresponding reconstructed output 160 lacks sufficient fidelity to reveal identifiable or sensitive information. For purposes of this disclosure, a “predetermined reconstruction threshold” is a fixed or dynamically adjustable numerical value that represents the maximum permissible reconstruction score 162 consistent with the privacy criterion 164. In an embodiment, the predetermined reconstruction threshold 166 may be derived empirically during system calibration by evaluating representative datasets of technical artifacts 118 and determining the reconstruction score 162 at which reconstructed outputs 160 become visually and/or semantically indistinguishable from the original input. For example, at least a processor 108 may analyze multiple classes of artifacts, such as mechanical drawings, architectural blueprints, and CAD specifications, and assign threshold values that differ across modalities, reflecting variations in acceptable reconstruction risk.

In further reference to FIG. 1B, in some embodiments, the predetermined reconstruction threshold 166 may be statically defined within system 100b configuration based on compliance frameworks (e.g., NIST SP 800-171, ITAR, or company-specific data-handling protocols). In other embodiments, the predetermined reconstruction threshold 166 may be dynamically updated using adaptive feedback from the reconstruction detector 156 and/or external privacy-assurance audits. For instance, system 100b may lower the predetermined reconstruction threshold 166 in response to newly identified security vulnerabilities and/or higher classification sensitivity of the input dataset. In an embodiment, at least a processor 108 may periodically compare each reconstruction score 162 to its corresponding threshold, and if the score exceeds the permissible value, system 100b may automatically trigger corrective actions such as reapplying the dimensionality-reduction function 132, invoking the feature-remapping procedure 168, and/or restricting downstream inference operations. By integrating the reconstruction score 162, privacy criterion 164, and predetermined reconstruction threshold 166 into a continuous evaluation loop, the disclosed system may provide an active privacy-enforcement mechanism that guarantees consistent, measurable, and verifiable protection of sensitive content throughout machine-learning operations on technical artifacts 118.

With continued reference to FIG. 1B, in an embodiment, at least a processor 108 may be configured to initiate a feature-remapping procedure 168 as a function of the reconstruction score 162 and the predetermined reconstruction threshold 166. For purposes of this disclosure, a “feature-remapping procedure” is a corrective transformation process applied to one or more feature representations 138 that have been determined to contain excessive reconstructive information. In an embodiment, the feature-remapping procedure 168 may serve as an adaptive mitigation mechanism that modifies the existing feature embeddings to further reduce an ability to reconstruct while preserving their discriminative capacity for downstream inference tasks. In some embodiments, the feature-remapping procedure 168 may operate by re-projecting feature vectors through an alternative dimensionality-reduction function 132 and/or privacy projection layer. For example, at least a processor 108 may introduce additional stochastic noise, random orthogonal rotations, or dropout-based sparsification to obfuscate high-fidelity spatial or lexical components that contributed to excessive similarity. In other embodiments, the remapping may involve parameter re-sampling of the embedding transformation network, such as updating weights of privacy-preserving encoder layers and/or regenerating basis vectors used in the projection matrix. In an embodiment, system 100b may optionally employ a differential privacy mechanism that injects controlled random perturbations into the feature vectors, ensuring mathematical guarantees of non-reconstructability while maintaining sufficient signal for metadata classification.

In continued reference to FIG. 1B, in an embodiment, the feature-remapping procedure 168 may include a feedback-controlled learning loop, wherein the reconstruction detector 156 and reconstruction model 158 provide real-time guidance to calibrate the extent of information loss. For instance, at least a processor 108 may iteratively apply remapping transformations and recompute the reconstruction score 162 until the privacy criterion 164 is satisfied. The resulting feature representation may then replace the original embedding within the active memory space, ensuring that no reconstructive version persists in storage or cache. By integrating this feature-remapping procedure 168 into the overall pipeline, the disclosed system may achieve a self-regulating privacy framework that continuously enforces compliance with defined reconstruction thresholds. In an embodiment, this adaptive control not only preserves confidentiality of controlled or proprietary information but may also enhance operational robustness by allowing the machine-learning system to self-correct in response to evolving data characteristics or model drift.

With further reference to FIG. 1B, in some embodiments, once the feature-remapping procedure 168 produces an updated set of privacy-preserving embeddings, at least a processor 108 may validate and normalize the remapped features prior to their use in downstream inference or metadata extraction. In an embodiment, this validation step may confirm that the remapped vectors conform to expected schema constraints, maintain consistent dimensionality across batches, and/or preserve semantic alignment with the target contextual attributes. In some cases, normalization may include scaling, data-type conversion, and/or unit harmonization to ensure interoperability with subsequent classifiers. Through this additional verification, system 100b may guarantee that the remapped feature representations 138 remain both compliant with privacy thresholds and functionally compatible with all downstream processing modules.

In further reference to FIG. 1B, in an embodiment, at least a processor 108 may be configured to determine, using a trained machine-learning classifier 134, at least one contextual attribute 136 as a function of the non-reversible feature representation 128. For purposes of this disclosure, a “trained machine-learning classifier” is a supervised or semi-supervised computational model configured to categorize, label, or infer descriptive attributes from privacy-preserving embeddings. In an embodiment, the trained machine-learning classifier 134 may include, for example, a convolutional neural network (CNN), recurrent or transformer-based architecture, random forest, gradient-boosted tree ensemble, and/or logistic regression model. Unlike conventional classifiers trained directly on human-readable or reconstructive input data, the trained machine-learning classifier 134 of the present disclosure may be optimized to operate entirely within the non-reversible feature space, thereby ensuring that inference can occur without access to the original textual or graphical content of the technical artifact 118. For purposes of this disclosure, a “contextual attribute” is a data element, label, or descriptor that is derived from or inferred based on the semantic, structural, or spatial context of an input artifact. In an embodiment, a contextual attribute may capture meaning or relationships expressed implicitly in the artifact, rather than merely reproducing its literal content, and may be generated through analysis of the artifact's feature representation, including non-reversible or dimensionally reduced embeddings. For example, a contextual attribute may represent a classification identifying the type, purpose, or category of a document or component; an entity recognition output such as a part number, specification, named entity, or other detected property; a relational property linking, for example, a drawing callout to a part feature; a contextual measurement or state such as a confidence score, uncertainty level, or provenance label; a schema element such as a field, tag, or object in a structured representation like XML or JSON; or a metadata field describing attributes such as the author, revision, creation date, or format of the underlying artifact.

In continued reference to FIG. 1B, for purposes of this disclosure, a “metadata field” is any derived attribute, label, or semantic tag that describes the content, structure, or classification of the technical artifact 118. Non-limiting examples may include identifiers such as document type (e.g., “architectural plan” or “mechanical drawing”), project number, component designation, material specification, revision status, author, and/or compliance category. In some embodiments, metadata fields may also include quality or integrity indicators inferred from the feature distribution, such as completeness of annotation or degree of geometric precision

With continued reference to FIG. 1B, in an embodiment, the trained machine-learning classifier 134 may receive as input the non-reversible feature representation 128 generated by the privacy-preserving embedding module. In an embodiment, the trained machine-learning classifier 134 may then apply learned decision boundaries and/or probabilistic inference to assign one or more contextual attributes corresponding to the most likely contextual meaning of the feature set. By performing this inference exclusively in a non-reversible domain, the trained machine-learning classifier 134 may support downstream automation, such as document indexing, compliance verification, or quotation analysis, without ever exposing sensitive or controlled data in raw or reconstructable form. This arrangement may yield a technical improvement in secure AI-driven document understanding, enabling high-accuracy metadata generation while maintaining strict privacy constraints at every processing stage.

Still referring to FIG. 1B, in an embodiment, determining the at least one contextual attribute 136 may include initializing parameters 142 of the trained machine-learning classifier 134 from a fixed weight store 144 at an initialization of each inference operation. For purposes of this disclosure, a “parameter” is a learned numerical value that defines an internal configuration of the machine-learning classifier. In an embodiment, parameters 142 may include, but are not limited to, weights, biases, scaling factors, and attention coefficients that collectively govern how the trained machine-learning classifier 134 transforms input feature representations 138 into output predictions. These parameters 142 may encode the model's learned knowledge from training, such as statistical relationships between patterns in the non-reversible feature space and their corresponding contextual attribute labels. For purposes of this disclosure, a “fixed weight store” is a secured, read-only memory location or data repository that persistently stores the trained parameters 142 of the classifier in a frozen state. In an embodiment, the fixed weight store 144 may reside in non-volatile storage (e.g., flash memory, secure enclave, or cryptographically signed model repository) and may be configured such that the model parameters 142 cannot be modified, fine-tuned, or written to during normal inference. By sourcing weights directly from the fixed weight store 144 at runtime, system 100b may ensure that each inference cycle begins from an identical, validated model state, thereby preventing contamination of learned representations or retention of sensitive intermediate data 146 between inference sessions. For purposes of this disclosure, an “inference operation” is a single, stateless execution cycle of the machine-learning classifier in which the processor applies the trained model parameters 142 to an input to produce one or more contextual attribute predictions. In an embodiment, each inference operation may be discrete and isolated: it may begin with model initialization from the fixed weight store 144, process the input embeddings to generate outputs, and terminate by deallocating temporary variables or cached tensors. In an embodiment, this stateless inference design may offer a critical privacy benefit, as it eliminates persistence of any data derived from controlled technical artifacts 118 across sessions and prevents inadvertent memorization of sensitive content by the model. By combining immutable parameter initialization with controlled inference sessions, system 100b may provide a reproducible and verifiably secure inference architecture, maintaining model consistency while upholding strict data-separation principles required for privacy-preserving machine-learning environments.

In continued reference to FIG. 1B, in an embodiment, determining the at least one contextual attribute 136 may include processing, using the trained machine-learning classifier 134, the non-reversible feature representation 128 to generate the at least one contextual attribute 136. In an embodiment, during this operation, the trained machine-learning classifier 134 may receive the privacy-preserving embedding as input and propagate it through one or more computational layers configured to extract higher-level semantic or relational features. These layers may include, without limitation, linear projection layers, convolutional kernels, transformer attention heads, and/or graph convolution modules, depending on the classifier architecture. In an embodiment, each layer may refine the abstracted representation by emphasizing correlations that correspond to metadata-relevant cues while discarding residual noise or non-informative variance. In an embodiment, the trained machine-learning classifier 134 may implement a forward-propagation routine, wherein the non-reversible feature representation 128 may be successively transformed through weighted summations, nonlinear activations, and normalization operations. In some cases, intermediate tensors produced at each stage may represent latent abstractions, such as contextual relationships between technical symbols, positional dependencies among geometric elements, and/or linguistic correlations among embedded tokens, that collectively inform the final prediction. In some embodiments, the classifier may further apply a softmax or sigmoid activation function at the output layer to generate one or more probability distributions corresponding to candidate contextual attributes. In an embodiment, at least a processor 108 may then select the contextual attribute(s) associated with the highest confidence score or exceeding a defined probability threshold.

Still referring to FIG. 1B, in an embodiment, because the input data at this stage consists solely of non-reversible feature vectors, the trained machine-learning classifier 134 may never operate on human-readable text or reconstructive geometry. This may ensure that even during intermediate computation, no recoverable image or text fragment is produced. In certain embodiments, the trained machine-learning classifier 134 may additionally incorporate attention-weight visualization or saliency mapping functions for auditability, allowing system 100b to verify which latent features contributed to a given metadata inference without exposing the underlying controlled data. By executing inference entirely within a privacy-preserving embedding space, the disclosed system may achieve an end-to-end secure metadata generation pipeline, wherein meaningful semantic outputs are produced from de-identified feature vectors without any dependency on original document content. In an embodiment, this may provide both a functional improvement in secure machine-learning operation and/or a compliance advantage for environments handling controlled unclassified or proprietary technical data.

With further reference to FIG. 1B, in an embodiment, determining the at least one contextual attribute 136 may include deallocating intermediate data 146 following generation of the at least one contextual attribute 136. For purposes of this disclosure, “intermediate data” is any transient data structure, tensor, cache, or memory buffer generated during the execution of the trained machine-learning classifier 134 that is not required for the final output. In an embodiment, intermediate data 146 may include activations, gradients, attention matrices, normalization statistics, temporary feature maps, and/or contextual embeddings derived during forward propagation. While these temporary artifacts are essential for model computation, they may contain residual statistical information that could theoretically be exploited to infer or reconstruct aspects of the original technical artifact 118 if retained. In some embodiments, upon completion of the inference operation, at least a processor 108 may initiate a secure memory deallocation routine configured to release and overwrite all intermediate data 146 stored in volatile memory. This may include, for example, explicit zeroization of GPU or CPU buffers, cache invalidation, and/or garbage-collection routines that ensure intermediate tensors cannot be recovered post-inference. In an embodiment, the deallocation process may occur automatically within the system's runtime environment and/or may be triggered as part of a controlled shutdown sequence following each inference cycle. In certain embodiments, at least a processor 108 may employ a memory hygiene protocol that logs the status of data deallocation events for auditability without recording the contents of the intermediate data 146 itself. In an embodiment, this log may be maintained within a secure system ledger to confirm compliance with data-handling policies and/or regulatory frameworks governing the processing of controlled unclassified information (CUI) 140. Additionally, system 100b may prevent the serialization or checkpointing of intermediate states to disk, ensuring that only final contextual attribute outputs, already decoupled from reconstructive information, are persisted or transmitted to downstream workflows 182. By deallocating intermediate data 146 immediately after metadata generation, system 100b may enforce a stateless and privacy-preserving inference environment. This design may prevent memory leakage, mitigate risks of inadvertent data persistence, and guarantee that each inference operation begins and ends in a clean computational state, consistent with the privacy-preserving principles described throughout the present disclosure.

With continued reference to FIG. 1B, in an embodiment, the trained machine-learning classifier 134 may have been trained using feature representations 138 derived from technical artifacts 118 containing controlled unclassified information (CUI) 140. For purposes of this disclosure, a “feature representation” is a structured encoding of the characteristics, properties, or contextual relationships of data extracted from a technical artifact. For purposes of this disclosure, “controlled unclassified information (CUI)” is information that, while not formally classified under national security designations, is subject to safeguarding or dissemination controls under law, regulation, or government-wide policy. Non-limiting examples of CUI may include engineering drawings, manufacturing process specifications, product blueprints, performance test data, material composition tables, and/or other technical documents covered under export-control frameworks such as the International Traffic in Arms Regulations (ITAR) or the Export Administration Regulations (EAR). In an embodiment, CUI may also include proprietary design documentation governed by nondisclosure agreements or internal data-handling protocols. In some embodiments, system 100b may access CUI indirectly by converting such technical artifacts 118 into non-reversible feature representations 128 prior to model training. In an embodiment, the conversion process may ensure that the trained machine-learning classifier 134 never observes reconstructive information such as explicit text labels, component geometries, and/or exact numerical dimensions. Instead, CUI-derived data may be represented as privacy-preserving embeddings containing only latent relational information sufficient to learn semantic patterns relevant to metadata inference. In an embodiment, training on these embeddings may enable the trained machine-learning classifier 134 to generalize from sensitive data distributions while maintaining legal and ethical compliance with CUI protection requirements.

Still referring to FIG. 1B, in an embodiment, CUI-based training datasets may be curated and stored within a segregated secure environment, such as a government-compliant enclave and/or isolated compute cluster with restricted access and encrypted storage. In an embodiment, the training pipeline may employ differential privacy, data-anonymization routines, and/or synthetic augmentation techniques to further obscure any identifiable attributes before ingestion. In some cases, periodic audits may verify that the model parameters 142 and resulting non-reversible feature representations 128 conform to mandated CUI-handling standards. By leveraging feature representations 138 derived from CUI rather than direct raw inputs, the disclosed system may achieve a technical improvement in privacy-compliant model training. In an embodiment, system 100b may allow the classifier to benefit from high-value, domain-specific data while ensuring that no original controlled document or reconstructive content is ever exposed, transmitted, or inferable from the trained model itself. This design may support the creation of high-fidelity, compliance-aligned AI systems capable of securely learning from sensitive technical artifacts 118 across defense, aerospace, and regulated manufacturing domains.

In further reference to FIG. 1B, in an embodiment, the trained machine-learning classifier 134 may include a plurality of classifiers 148, wherein each classifier of the plurality of classifiers 148 has been trained on a distinct subset of feature values 150. For purposes of this disclosure, a “plurality of classifiers” refers to multiple independently trained machine-learning models, each configured to perform inference on a partitioned portion of the overall non-reversible feature representation 128. In an embodiment, this ensemble structure may enable system 100b to distribute analytical responsibility across specialized models, reducing overfitting and enhancing robustness while maintaining strict privacy boundaries between different data modalities or feature domains. For purposes of this disclosure, a “distinct subset of feature values” is a logically or statistically separable portion of the feature space corresponding to a particular modality, context, or semantic class of the technical artifact 118. For instance, one classifier may be trained on textual features derived from embedded annotations and/or material specifications, another may process geometric or topological features extracted from vectorized line drawings, and a third may focus on relational or layout features representing spatial hierarchies within the document. In certain embodiments, system 100b may further subdivide feature subsets along functional boundaries, such as metadata categories, feature-type clusters, or security sensitivity levels, ensuring that no single classifier possesses sufficient aggregate information to reconstruct or infer sensitive content.

With continued reference to FIG. 1B, in an embodiment, each classifier of the plurality of classifiers 148 may be trained using a dedicated training dataset containing non-reversible feature representations 128 restricted to its respective subset of feature values. In an embodiment, during training, these classifiers may learn complementary but non-overlapping representations, each producing partial metadata predictions based on their specialized domain. This modular training approach may provide both a computational advantage, by allowing parallelized inference, and/or a privacy advantage, as it prevents any single model from accessing or correlating the full feature set of the original technical artifact 118. In some embodiments, the plurality of classifiers 148 may be organized within an ensemble inference framework, such as a voting, stacking, or weighted-aggregation system. In some cases, the outputs from individual classifiers may then be combined downstream to yield a unified metadata prediction with confidence calibration. This distributed model design may not only increase system interpretability and fault tolerance but may also strengthen the privacy-preserving architecture by isolating feature flows across separate, non-reconstructive processing channels.

Still referring to FIG. 1B, in an embodiment, wherein the trained machine-learning classifier 134 includes the plurality of classifiers 148, determining the at least one contextual attribute 136 may include generating, using the plurality of classifiers 148, a plurality of candidate contextual attributes 152, wherein each candidate contextual attribute is associated with a corresponding confidence score 154. For purposes of this disclosure, a “candidate contextual attribute” is a potential or provisional contextual output generated by an individual classifier operating on its designated subset of feature values. In an embodiment, each candidate contextual attribute may represent the classifier's independent inference regarding one or more descriptive attributes of the technical artifact 118, based solely on the portion of the non-reversible feature representation 128 it processes. Non-limiting examples of candidate contextual attributes may include a predicted document type, a proposed project identifier, a material classification, a component revision label, and/or a compliance designation inferred from the embedded contextual patterns. For purposes of this disclosure, a “corresponding confidence score” is a quantitative or probabilistic measure indicating the classifier's level of certainty in the correctness of its associated candidate contextual attribute. In an embodiment, the corresponding confidence score 154 may be computed using one or more statistical or learned functions, such as softmax probabilities, logit-normalized likelihoods, entropy-based calibration metrics, or Bayesian uncertainty estimates derived from model variance. For example, if a classifier predicts that an artifact most likely corresponds to the metadata label “Structural Plan,” it may assign a confidence score of 0.92, reflecting a 92% inferred probability that this label is correct given the observed feature distribution.

In further reference to FIG. 1B, in some embodiments, each classifier of the plurality of classifiers 148 may output multiple candidate contextual attributes ranked according to descending confidence scores. In an embodiment, at least a processor 108 may aggregate these results into a candidate metadata pool containing parallel predictions from all classifiers, forming a probabilistic ensemble representation of the artifact's descriptive attributes. This distributed inference design may allow system 100b to cross-validate predictions across classifiers trained on distinct feature domains, enhancing both accuracy and reliability without compromising privacy. Because each classifier operates only on a partitioned subset of the non-reversible feature representation 128, the generation of candidate contextual attributes may remain fully compliant with the privacy constraints established by the reconstruction-detector subsystem. By producing candidate contextual attributes with associated confidence scores, system 100b may enable dynamic downstream selection and weighting, allowing subsequent processing modules to identify the most reliable metadata predictions, reconcile discrepancies, and adaptively tune ensemble parameters 142 to optimize performance while preserving data security.

With further reference to FIG. 1B, in an embodiment, wherein the trained machine-learning classifier 134 includes the plurality of classifiers 148, determining the at least one contextual attribute 136 may include selecting, as the at least one contextual attribute 136, a candidate contextual attribute of the plurality of candidate contextual attributes 152 as a function of the corresponding confidence score 154. In an embodiment, at least a processor 108 may aggregate outputs from each classifier into a unified decision layer that ranks or filters the candidate contextual attributes according to their respective confidence values. Further, system 100b may then select one or more of these candidates as the final metadata output(s) using one or more selection functions, which may include, without limitation, threshold-based filtering, probabilistic sampling, ensemble averaging, and/or weighted voting mechanisms. In one embodiment, at least a processor 108 may implement a maximum-likelihood selection routine, wherein the candidate contextual attribute with the highest confidence score exceeding a predetermined minimum threshold is designated as the final contextual attribute. In other embodiments, system 100b may employ a weighted aggregation model, wherein candidate contextual attributes from multiple classifiers are combined according to their relative confidence scores to produce a consensus output. For example, if three classifiers each predict a material classification with respective confidences of 0.9, 0.8, and 0.4, system 100b may compute a weighted mean or ensemble vote that favors the stronger predictions while discounting lower-confidence outputs.

Still referring to FIG. 1B, in an embodiment, the confidence-based selection process may optionally include uncertainty calibration, wherein confidence scores are normalized or adjusted based on classifier-specific performance metrics, validation data, and/or recent inference history. This may ensure that confidence values remain comparable across classifiers trained on heterogeneous subsets of feature values. In certain embodiments, at least a processor 108 may apply an adaptive confidence threshold, dynamically tuning the minimum score required for acceptance based on the criticality of the contextual attribute or the privacy level of the document being processed. By employing confidence-driven selection, system 100b may achieve a technically robust and privacy-aligned inference pipeline. In an embodiment, this mechanism may maximize accuracy while preserving interpretability and enable continuous auditing of decision quality without reintroducing reconstructive content. Furthermore, because each confidence score reflects model certainty derived exclusively from non-reversible embeddings, this decision-making process may preserve the system's core privacy guarantees while supporting high-integrity, explainable metadata extraction across diverse technical artifacts 118.

In continued reference to FIG. 1B, in an embodiment, at least a processor 108 may be configured to apply a hallucination-mitigation routine 170 to the at least one contextual attribute 136. For purposes of this disclosure, a “hallucination-mitigation routine” is a verification and correction process configured to detect, quantify, and suppress instances where a machine-learning classifier generates metadata that is inconsistent with or unsupported by the original non-reversible feature representation 128. In an embodiment, the routine may address the phenomenon commonly known as “model hallucination,” in which an AI system extrapolates or infers spurious information that does not correspond to any actual feature value extracted from the input artifact. In an embodiment, the hallucination-mitigation routine 170 may operate as a post-inference validation layer positioned downstream of the trained machine-learning classifier 134. In some cases, the hallucination-mitigation routine 170 may evaluate each generated contextual attribute for logical and statistical consistency relative to the privacy-preserving feature data derived from the technical artifact 118. For example, if the trained machine-learning classifier 134 predicts a material type or dimensional value that cannot be corroborated by the embedded feature vectors representing material annotations and/or geometric entities, the hallucination-mitigation routine 170 may flag that contextual attribute as unreliable. In some embodiments, the hallucination-mitigation routine 170 may include a combination of rule-based validation mechanisms and machine-learning-based consistency models. In an embodiment, rule-based mechanisms may apply deterministic checks, such as verifying that predicted numeric fields fall within permissible engineering tolerances or that category labels correspond to known ontology values. Alternatively, in an embodiment, machine-learning-based consistency models may employ contrastive or attention-alignment techniques to determine whether semantic and contextual relationships between predicted metadata and input features are statistically coherent. By executing the hallucination-mitigation routine 170 immediately after metadata generation, system 100b may ensure that only verified, evidence-supported contextual attributes are accepted for downstream use. In an embodiment, this post-processing safeguard may provide a technical improvement in reliability and trustworthiness of AI-driven document understanding systems, reducing the risk of erroneous metadata propagation while maintaining compliance with the system's overarching privacy-preserving architecture.

With further reference to FIG. 1B, in some embodiments, the hallucination-mitigation routine 170 may itself be implemented as a trainable model or hybrid system that combines learned statistical alignment with rule-based consistency evaluation. In an embodiment, the hallucination-mitigation routine 170 may be trained or retrained using datasets that pair metadata predictions with corresponding ground-truth feature values derived from validated technical artifacts 118. During training, the hallucination-mitigation routine 170 may learn to distinguish between metadata that is consistent with feature evidence and metadata that represents a hallucinated or unsupported inference. In an embodiment, the ground-truth annotations may include verified associations between extracted textual labels, graphical symbols 122, and corresponding contextual attributes such as dimensions, materials, or component identifiers. In an embodiment, the training process may employ a contrastive-learning framework or supervised classification approach, wherein the hallucination-mitigation routine 170 minimizes a loss function that penalizes inconsistency between predicted metadata and authentic feature evidence. In an embodiment, positive examples may include correctly aligned metadata-feature pairs (e.g., a “Material: Steel A36” metadata prediction supported by an extracted feature value describing “Steel A36”), while negative examples may include hallucinated predictions or mismatched associations (e.g., a predicted “Material: Aluminum” when no corresponding feature evidence exists). In an embodiment, the model may compute alignment confidence scores using vector similarity, cross-attention alignment, or mutual information metrics, refining its internal parameters 142 to improve sensitivity to unsupported metadata. In an embodiment, retraining of the hallucination-mitigation routine 170 may occur periodically or adaptively in response to evolving data distributions, updated document formats, or new classifier architectures. For example, as the upstream machine-learning classifier encounters novel symbol sets or industry-specific terminology, the hallucination-mitigation model may be incrementally retrained using newly validated artifacts to ensure accurate alignment under expanded operational conditions. In certain embodiments, retraining may also incorporate feedback from human review or automated audit logs that identify recurring hallucination patterns, enabling the system to continuously reduce error rates over time. By training and maintaining the hallucination-mitigation routine 170 in this fashion, system 100b may achieve a self-correcting inference pipeline capable of enforcing semantic integrity across diverse technical domains while preserving the privacy and non-reversibility of the underlying feature representations 138.

Still referring to FIG. 1B, in an embodiment, applying the hallucination-mitigation routine 170 to the at least one contextual attribute 136 may include comparing the at least one contextual attribute 136 to the at least one feature value 126 extracted from the technical artifact 118. For purposes of the present context, “comparing” refers to the computational process of evaluating the degree of correspondence or alignment between a generated contextual attribute and the evidentiary feature values derived during feature-extraction operations. In an embodiment, this comparison may establish whether each metadata prediction is logically and statistically supported by verifiable data present within the non-reversible feature representation 128 of the technical artifact 118. In some embodiments, the comparison may be performed using semantic-similarity analysis, embedding-space correlation, or attention-alignment scoring. For textual metadata, such as material specifications or project identifiers, at least a processor 108 may encode both the predicted contextual attribute and the extracted textual feature values into a shared embedding space and compute cosine similarity, dot-product attention weights, or cross-entropy divergence to quantify alignment. For graphical or geometric metadata, such as dimensional values or part labels, at least a processor 108 may evaluate spatial consistency by comparing geometric attributes, bounding-box coordinates, or topological relationships of the predicted entities to corresponding visual feature embeddings within the technical artifact 118. In certain implementations, the comparison process may also integrate rule-based validation criteria that reflect domain-specific constraints. For example, if the predicted contextual attribute specifies a dimension or tolerance value, at least a processor 108 may verify that a corresponding numerical feature exists within the extracted features and that the magnitude lies within an acceptable engineering range. Similarly, for categorical metadata, the routine may confirm that the predicted label matches one of the recognized ontology classes encoded within the system's feature dictionary. By performing this comparison within the privacy-preserving embedding space, system 100b may avoid accessing any reconstructive text or imagery while still validating the semantic integrity of its inferences. In an embodiment, the resulting comparison metrics form the basis for calculating a consistency score 172 in subsequent operations, allowing system 100b to detect unsupported or contradictory predictions and selectively suppress or correct them without compromising data security or model transparency.

With continued reference to FIG. 1B, in an embodiment, applying the hallucination-mitigation routine 170 to the at least one contextual attribute 136 may include adjusting the at least one contextual attribute 136 as a function of a consistency score 172 and a predetermined hallucination threshold 174. For purposes of this disclosure, a “consistency score” is a quantitative measure representing the degree of alignment between a predicted contextual attribute and the corresponding evidentiary feature values extracted from the technical artifact 118. In an embodiment, the consistency score 172 may provide a statistical basis for determining whether the contextual attribute is verifiably supported by input data or represents an unsupported, potentially hallucinatory inference. In an embodiment, the consistency score 172 may be computed as a function of the comparison results described previously, using one or more metrics such as semantic similarity, vector correlation, edit distance, or structural overlap. For instance, if the predicted contextual attribute “Material: Aluminum” corresponds to feature embeddings associated with the phrase “Aluminum Alloy 6061” within the artifact, system 100b may compute a high cosine similarity value (e.g., 0.91), indicating strong consistency. Conversely, if the classifier predicts “Material: Carbon Fiber” in the absence of any corresponding feature evidence, the resulting similarity score may be substantially lower, signaling a likely hallucination. In an embodiment, at least a processor 108 may normalize these scores to a defined range (for example, 0 to 1) to enable consistent interpretation across metadata categories and modalities.

Still referring to FIG. 1B, for purposes of this disclosure, a “predetermined hallucination threshold” is a configurable numerical limit used to distinguish valid contextual attributes from hallucinated ones. In an embodiment, the predetermined hallucination threshold 174 may define the minimum allowable consistency score 172 required for a contextual attribute to be accepted as credible. In an embodiment the threshold value may be established empirically during system calibration, determined dynamically through adaptive feedback from prior inference sessions, and/or set according to domain-specific confidence requirements. In some embodiments, multiple hallucination thresholds may be maintained for different metadata classes, for instance, a higher threshold for safety-critical data such as pressure ratings and a lower threshold for non-critical descriptors such as drawing titles. In an embodiment, if at least a processor 108 determines that the consistency score 172 for a contextual attribute falls below the predetermined hallucination threshold 174, system 100b may adjust, suppress, or re-query that contextual attribute. In some cases, adjustment may involve reweighting classifier confidence scores, substituting alternative candidate metadata from the ensemble, and/or marking the field for review or retraining. In some embodiments, the hallucination-mitigation routine 170 may trigger an iterative refinement loop, in which system 100b re-evaluates candidate contextual attributes using contextual cross-validation until all accepted outputs satisfy or exceed the hallucination threshold. By quantifying metadata reliability through consistency scoring and threshold-based adjustment, system 100b may provide a technical improvement in inference accuracy and trustworthiness, ensuring that every generated contextual attribute is both semantically justified and privacy-compliant. This mechanism may allow the AI pipeline to maintain interpretability and accountability, particularly in regulated or high-stakes domains where metadata accuracy is critical.

With continued reference to FIG. 1B, in an embodiment, the outputs of the hallucination-mitigation routine 170 may be re-evaluated within the system's broader privacy-preserving inference cycle to ensure that corrective adjustments do not compromise non-reversibility or violate the established privacy criterion 164. After contextual attributes have been adjusted or validated through the hallucination-mitigation process, at least a processor 108 may optionally re-encode the modified feature relationships into the non-reversible embedding space and recompute a reconstruction score 162 using the reconstruction detector 156. In an embodiment, this verification step may confirm that the mitigation process has not reintroduced reconstructive bias and/or residual correlations capable of revealing controlled information. By integrating hallucination correction with reconstruction validation, system 100b may achieve a closed-loop compliance framework in which each stage, feature extraction, embedding, inference, correction, and verification, operates cohesively to maintain both semantic accuracy and strict privacy integrity across all technical artifact 118 types.

In further reference to FIG. 1B, in an embodiment, at least a processor 108 may be configured to validate the at least one contextual attribute 136 against a predefined schema 176. For purposes of this disclosure, a “predefined schema” is a structured data model, ontology, or schema definition that specifies the expected organization, type, range, and relational constraints of contextual attributes generated by the system. In an embodiment, the predefined schema 176 may be implemented as a machine-readable specification, such as an XML schema, JSON schema, database schema, or graph-based ontology, that defines valid field names, allowable data types 178, required relationships between fields, and/or permissible value domains for each metadata attribute. In an embodiment, once contextual attributes are generated through inference and refined through hallucination-mitigation, at least a processor 108 may compare each field to the predefined schema 176 to ensure compliance with structural and semantic rules. For example, the predefined schema 176 may require that a “Material” field contain a text string from an approved material vocabulary, that a “Revision Number” be expressed as an integer, or that “Drawing Date” follow a specific ISO 8601 date format. In some cases, validation may also confirm relational dependencies, such as verifying that a “Component ID” corresponds to a valid “Assembly ID” within the same artifact family. In some embodiments, the predefined schema 176 may be domain-specific, reflecting unique metadata standards for industries such as aerospace, architecture, or defense manufacturing. Additionally, the predefined schema 176 may also incorporate CUI-handling classifications, ensuring that contextual attributes tagged with certain sensitivity levels are properly flagged, masked, or restricted from downstream exposure. In an embodiment, at least a processor 108 may maintain multiple schemas concurrently, selecting the appropriate one dynamically based on artifact type or organizational policy. By enforcing conformance to a predefined schema 176, system 100b may ensure that generated contextual attributes are not only accurate but also interoperable with existing document management systems, enterprise databases, or compliance audit pipelines. In an embodiment, this validation step may provide a technical improvement in data quality assurance and automation reliability, enabling seamless downstream integration while maintaining the privacy-preserving design established throughout the inference process.

Still referring to FIG. 1B, in an embodiment, at least a processor 108 may be configured to convert one or more of data types 178 and units 180 as a function of validating the at least one contextual attribute 136 against the predefined schema 176. For purposes of this disclosure, a “data type” is the categorical format or representation assigned to a contextual attribute that dictates how the field is interpreted and processed by subsequent systems. For purposes of this disclosure, a “unit” is the physical or contextual measurement scale associated with quantitative metadata. For example, including but not limited to units 180 of length, mass, pressure, temperature, and/or time. In an embodiment, after validating the contextual attributes against the predefined schema 176, at least a processor 108 may analyze each field's current data representation and determine whether conversion is required to achieve conformance. For instance, a “Length” field inferred as a string value (“250 mm”) may be converted to a normalized numerical float value (250.0) with an associated unit tag (“millimeters”). Similarly, an inferred “Pressure” field expressed in pounds per square inch (psi) may be converted to megapascals (MPa) using a schema-defined unit conversion factor, ensuring consistency across all documents within a project or repository.

In continued reference to FIG. 1B, in some embodiments, at least a processor 108 may maintain a type-mapping and unit-conversion library encoded within the schema definition. In an embodiment, this library may include conversion coefficients, permitted value ranges, and canonical unit representations that align with industry or regulatory standards (e.g., ISO, ASME, ASTM). In some embodiments, at least a processor 108 may further apply context-aware disambiguation, resolving ambiguities such as whether a numerical value corresponds to inches or millimeters based on associated metadata like region, drawing standard, or customer specification. In an embodiment, the conversion of data types 178 and units 180 may not only standardize metadata representation but may also provide a technical improvement in downstream interoperability. By enforcing consistent numeric and categorical formats, system 100b may enable seamless integration of validated metadata into external computer-aided design (CAD) platforms, enterprise resource planning (ERP) systems, and compliance auditing pipelines. Moreover, because conversions may occur on schema-validated, privacy-preserving metadata rather than original document content, this process maintains the system's confidentiality guarantees while enhancing the precision and uniformity of its output data.

With further reference to FIG. 1B, in an embodiment, at least a processor 108 may be configured to reformat the at least one contextual attribute 136 for integration into a downstream workflow 182. For purposes of this disclosure, a “downstream workflow” is any automated or semi-automated process, system, or application that consumes, acts upon, or displays the validated contextual attributes produced by the present system. In an embodiment, downstream workflows 182 may include, but are not limited to, enterprise data management systems, document control repositories, manufacturing execution systems (MES), enterprise resource planning (ERP) platforms, compliance audit modules, and/or analytics and reporting dashboards. In some embodiments, downstream workflows 182 may also include machine-to-machine interfaces such as application programming interfaces (APIs), message queues, or secure data exchange protocols configured to ingest structured metadata for automated decision-making or recordkeeping. In an embodiment, reformatting the at least one contextual attribute 136 may include transforming data structure, syntax, or encoding to conform with the interface requirements of the target downstream workflow 182. For example, metadata validated within the system's internal schema (e.g., stored as JSON objects or vectorized embeddings) may be reformatted into XML, CSV, or SQL-compatible structures depending on the destination system's requirements. In certain embodiments, at least a processor 108 may apply naming convention translation, field mapping, or namespace alignment, ensuring that the contextual attributes correspond to the standardized identifiers and data models of the receiving environment. In some implementations, at least a processor 108 may perform batch or streaming export of reformatted metadata to downstream systems using secure, authenticated communication protocols such as HTTPS, AMQP, or message-based REST APIs. In an embodiment, at least a processor 108 may also attach contextual metadata, such as version identifiers, provenance tags, or cryptographic signatures, to facilitate traceability and verification in multi-system environments. In an embodiment, all reformatting and transmission operations may be performed exclusively on non-reconstructive contextual attributes, ensuring that no sensitive textual or graphical data from the original technical artifact 118 is exposed or transmitted. By enabling seamless, standards-compliant integration into downstream workflows 182, the disclosed system may provide a technical improvement in the automation and traceability of document understanding processes. In an embodiment, system 100b may bridge privacy-preserving AI inference with practical enterprise applications, allowing secure metadata to flow from model output to operational systems, while maintaining complete compliance with data-protection and non-reversibility principles established in earlier stages of the pipeline.

Taken together, the embodiments described herein may provide an end-to-end, privacy-preserving system for automated metadata extraction and integration from technical artifacts 118. Beginning with the secure ingestion of textual and graphical content, system 100b may verify input integrity, authenticate data sources, and normalize file formats to ensure compatibility with downstream feature-extraction operations. In an embodiment, extracted features are embedded into non-reversible representations, thereby retaining contextual meaning while mathematically eliminating reconstructive detail. These privacy-preserving embeddings may serve as the foundation for inference by trained machine-learning classifiers 134 that operate exclusively within de-identified feature spaces. Hallucination-mitigation routines 170, reconstruction detectors 156, and feature-remapping procedures 168 may ensure that every inferred contextual attribute is both semantically valid and irreversibly separated from its source content. In an embodiment, the validated contextual attributes may then be standardized through schema-based validation, type and unit conversion, and reformatting for integration into downstream workflows 182 such as enterprise databases, compliance systems, or analytics pipelines. In an embodiment, through this coordinated sequence of operations, system 100b may achieve a technical improvement in the secure automation of document understanding. System 100b may enable artificial intelligence to extract meaningful, verifiable metadata from sensitive engineering or manufacturing artifacts without ever exposing or reconstructing controlled information. The architecture's modular design may additionally allow it to scale across diverse domains, including defense, aerospace, energy, and industrial design, while maintaining rigorous privacy, compliance, and interoperability standards. As a result, the disclosed invention provides both a functional enhancement in machine-learning performance and a transformative advancement in the privacy-assured processing of technical documentation.

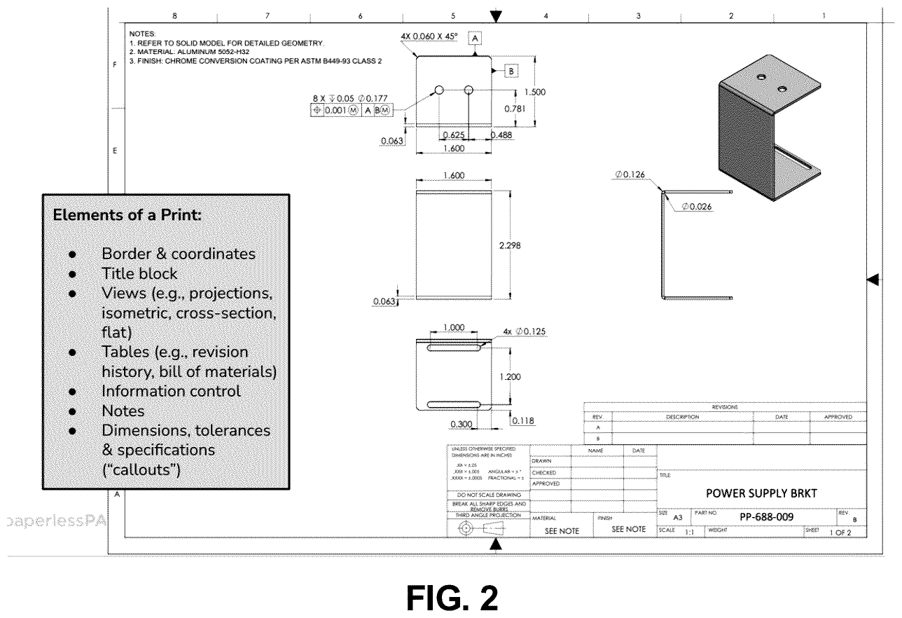

Referring now to FIG. 2, an exemplary embodiment of a system 200 for metadata extraction from controlled technical artifacts is illustrated. In some cases, prior implementations of metadata extraction for engineering drawings have relied primarily on machine-learning (ML) techniques designed to identify and extract predefined metadata fields from 2D documents. These prior solutions focus on structured pattern recognition rather than context-aware inference, typically using static or semi-supervised ML classifiers trained to locate fields such as part number, drawing number, revision identifier, or title block information. In an embodiment, drawings may include associated files, such as 3D CAD models, but conventional algorithms may operate independently of such contextual information. In contrast, the present disclosure introduces an AI-based approach, in particular, a large-language-model (LLM)-assisted metadata extraction architecture, that extends beyond traditional form-based methods. Whereas legacy ML systems depend on rigid coordinate templates or title block heuristics, the disclosed AI system performs semantic and spatial inference to identify metadata regardless of where it appears within the document or its accompanying digital structure. As a result, the disclosed method may generalize across diverse document formats and layouts, eliminating the need for hand-engineered title-block templates and enhancing robustness in heterogeneous manufacturing data environments.

In an embodiment, it is recognized that engineering drawings and other technical artifacts rarely conform to a fixed or form-based layout. Critical metadata may appear in arbitrary regions of the document, within a title block, dispersed throughout callout annotations, or even embedded in the filename of the digital artifact itself. Accordingly, the system may employ a machine learning model to infer which textual elements within the drawing are most likely to represent relevant metadata fields. To achieve this, the page may be decomposed into tokens derived from extracted textual content. The text may be obtained directly from a searchable PDF layer or using optical character recognition applied to an image-based or raster version of the drawing. Each token is associated with its textual value and spatial coordinates, such as a bounding box describing its position on the page. For each token, a set of numerical and categorical features may be generated. Numerical (scalar) features may include the token's distance from defined reference points on the page, the number and type of characters (e.g., digits, letters, or symbols), estimated font size, or spatial proximity to known metadata labels. Categorical features may indicate linguistic or structural attributes, such as whether the token corresponds to a recognized word, conforms to an expected alphanumeric format (for example, a CAGE code or revision identifier following ASME Y14.35M), or appears in the filename associated with the drawing. These features may be computed for each document within a labeled training dataset in which the true metadata values are known. In an embodiment, the feature vectors and corresponding metadata labels may be used to train a machine-learning classifier, which may include, without limitation, a random forest, gradient boosted tree ensemble, or support vector machine. During inference, the trained model may receive feature vectors generated from an unseen document and compute, for each token, a probability that the token represents a desired metadata field. Tokens with probabilities above a configurable threshold are selected as predicted metadata. In some embodiments, the model may output multiple candidate tokens per field for subsequent refinement, weighting, and/or fusion in downstream processing. When a single document references multiple parts or assemblies, all tokens exceeding the threshold may be treated as valid extractions.

With continued reference to FIG. 2, in an embodiment, the process of converting tokenized strings into feature representations may be intentionally non-reversible. In an embodiment, the transformation may discard sufficient contextual detail such that the original textual content cannot be reconstructed from the feature representation. As a result, the trained classifier does not contain or retain any recoverable content from the training documents themselves. This design may enable the model to be trained using sensitive data, including Controlled Unclassified Information, while ensuring compliance with data-handling and export-control regulations. The resulting model can therefore be distributed, deployed, or shared across users and organizations without exposing restricted training material.

In an embodiment, FIG. 2 further illustrates how metadata extraction may support quoting, inspection, and quality-analysis workflows. Engineering drawings, also referred to as blueprints or prints, may encode several distinct classes of information, including two-dimensional views, geometric callouts, and textual notes. These elements may collectively describe a component's geometry, tolerances, and manufacturing intent. When a three-dimensional model is unavailable, the two-dimensional projections may serve as the primary geometric reference; even when a model exists, the views provide contextual information that associates dimensional annotations, weld indicators, and other manufacturing notes with particular features. Within the disclosed system, an uploaded drawing may be rendered within a document-viewing interface that enables paging, zooming, and annotation. In some cases, the system may analyze each page to detect and classify elements such as views, callouts, title blocks, and notes, identifying their bounding regions and associated textual content. Detected elements may be subsequently correlated with metadata predictions generated by the trained classifier, enabling the system to surface probable part identifiers, revisions, and other descriptive fields to the user or to downstream analytical workflows.

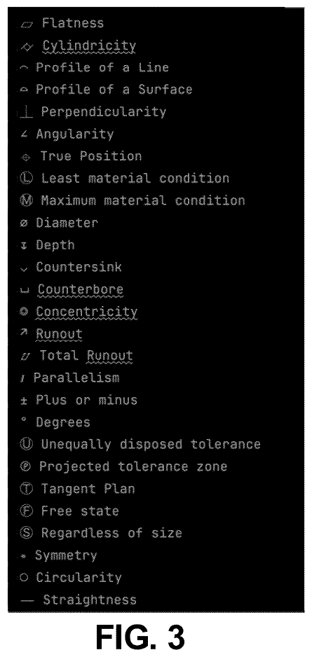

With reference to FIG. 3, in an embodiment, the text identified within an engineering drawing may include standard alphanumeric characters corresponding to the drawing's native language as well as a variety of specialized manufacturing symbols. These symbols may represent domain-specific graphical notations, such as surface finishes, weld indicators, and/or geometric dimensioning and tolerancing symbols, that are not part of a conventional language alphabet. Standard optical character recognition (OCR) systems may be limited to natural-language characters and thus may fail to recognize or accurately classify these specialized symbols. In an embodiment, to address this limitation, the disclosed system may extend an OCR engine through the creation of a custom language model trained to recognize technical characters. A compatible example OCR framework is the open-source Tesseract OCR system. Training data for the custom model may be obtained through synthetic generation or manual annotation of representative engineering drawings. In an embodiment, each training instance may include an image of one or more text or symbol lines and corresponding ground-truth data specifying the correct character sequence. The model may optionally incorporate bounding box annotations to refine character localization. When a Unicode representation exists for a symbol, that Unicode value can serve as the ground-truth label. In cases where no corresponding Unicode symbol exists, a designated substitute character or placeholder encoding may be employed to maintain consistency across the dataset. Once trained, the custom OCR language model may enable the system to accurately extract both textual and symbolic information from drawings containing specialized manufacturing notation. In an embodiment, for non-textual elements or regions that do not conform to discrete character sets, such as title blocks, callouts, or view boundaries, the system may apply computer vision-based object detection techniques. Object detection models are trained on labeled image datasets in which bounding boxes define the positions of desired elements. A trained object detector can infer, on unseen documents, the presence and spatial location of such elements. The detector may be configured to identify a variety of targets, including title blocks, note regions, border outlines, callouts, or specific technical symbols. Suitable detection algorithms include, without limitation, convolutional neural networks, Faster R-CNN, and transformer-based architectures such as the Detection Transformer (DETR).

In an embodiment, the system may employ multiple detection techniques concurrently to identify overlapping or related elements within a document. Each technique may exhibit distinct performance characteristics, sensitivity profiles, or error tendencies depending on the input domain or document style. To improve robustness, the system may apply a fusion algorithm that combines the results from different detectors to produce a unified interpretation of the page. In an embodiment, the fusion algorithm may receive, as input, detections from one or more techniques, performance metrics for each detector (such as precision, recall, or class-specific accuracy), individual detection confidence scores, and statistical priors describing the expected co-occurrence or spatial relationships of document elements. By integrating these heterogeneous inputs, the fusion algorithm may compute a joint probability distribution over the detected entities, producing a final prediction of the most likely document composition. The resulting fused representation may improve the overall precision and recall of the system and ensure consistent detection across diverse drawing formats and layouts.

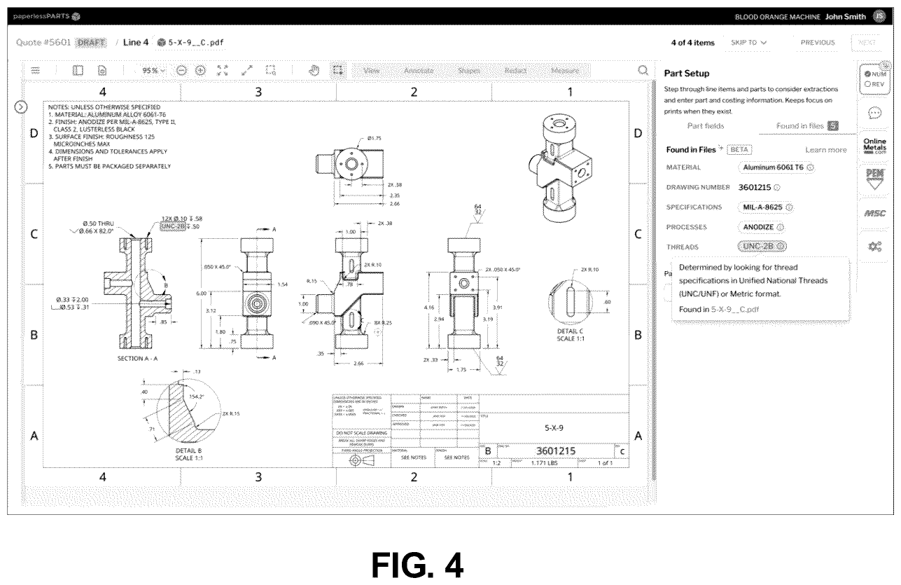

In an embodiment, FIG. 4 illustrates an example in which two detections generated by different algorithms may be treated as representing the same element when their corresponding bounding boxes overlap beyond a defined spatial threshold. In an embodiment, the fusion algorithm may aggregate such detections and compute an updated probability that each detected element corresponds to a true instance of a target class. In some cases, the probability calculation may employ Bayesian inference, wherein the posterior probability of a detection being correct is determined as a function of (i) the confidence scores of the contributing detections, (ii) the empirically measured performance characteristics of each detection model (such as precision and recall), and (iii) prior probabilities representing the expected occurrence of that element type within the current document context. Detections whose posterior probabilities exceed a configurable threshold may be surfaced to the user through an interactive interface. These detections may be presented in a concise, scrollable list or side panel, each entry corresponding to a visually highlighted region of the document. In some cases, the user may select a listed detection to view its position within the drawing, verify its correctness, or perform context-specific actions. In an embodiment, the interface may support both corrective and confirmatory user feedback. Users may manually annotate or label elements that were not automatically detected or delete extraneous detections that are inaccurate or irrelevant. All user interactions may be stored in a centralized repository as structured feedback data. This feedback may be subsequently incorporated into a reinforcement learning routine or other model retraining process to refine detector performance, recalibrate confidence thresholds, and update the statistical priors governing element occurrence within the document domain. Over time, these user-driven adjustments may enable the system to continuously improve its detection accuracy and adapt to new drawing conventions or symbol sets encountered in production environments.

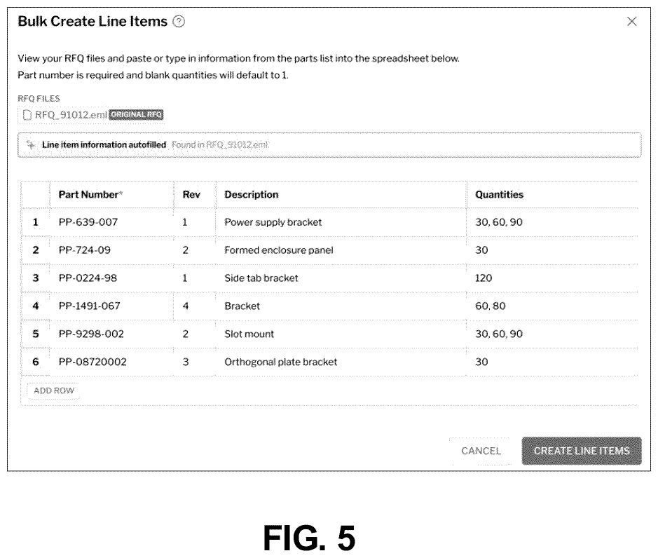

In an embodiment, FIG. 5 illustrates an AI-supported user assistance framework configured to augment human decision-making in document and quotation workflows. The disclosed system may integrate artificial intelligence components into the user interface to assist with repetitive, data-intensive, and/or cognitively demanding tasks, while maintaining full user oversight and control. The AI-supported system may operate according to a defined set of guiding principles designed to ensure user trust, transparency, and data security. In one embodiment, these guiding principles include a commitment to security and compliance, the responsible use of customer data, transparency with human review, and continuous testing and improvement. All AI-assisted features may be implemented in accordance with industry standards such as FedRAMP and NIST, and the system's infrastructure and R&D environment may adhere to strict internal access and security controls to ensure compliance with requirements applicable to Controlled Unclassified Information (CUI) and Cybersecurity Maturity Model Certification (CMMC) Level 2. In this manner, no customer data may be transmitted to or processed by non-compliant third-party systems. Customer-owned data, including pricing formulas, parametric cost models, and proprietary manufacturing data, may never be shared across customers or external systems. Only technical data such as engineering drawings may be used for model training, and only under secure, access-controlled conditions. In some embodiments, AI modules within the system may provide suggestions or automated inferences, but ultimate decision-making authority remains with the human operator. Each AI-generated recommendation may be clearly identified as such within the user interface, allowing users to accept, modify, or reject the suggestion. Before any feature is deployed, it may be benchmarked against defined performance metrics, with results continuously logged and analyzed to measure performance, retrain algorithms, and improve accuracy through iterative testing. This framework may support multiple AI-assisted capabilities within the application environment, including intelligent quotation setup, metadata extraction, and context-driven file association.

In an embodiment, one representative use case of the AI-supported framework involves automated quote setup based on a received request-for-quotation (RFQ). RFQs may arrive as email threads containing free-text descriptions of parts and projects, optionally accompanied by attached technical files such as two-dimensional drawings or three-dimensional CAD models. The user may upload the RFQ package directly or forward the email to a designated system address. The system may then assist the user in configuring quote line items by automatically identifying candidate part numbers, revisions, descriptions, and requested quantities. The AI quotation service may operate through a three-stage extraction pipeline executed sequentially, wherein the first stage handles structured tabular data, the second addresses semi-structured data with partial ambiguity, and the third employs a large language model to interpret unstructured text. When an earlier stage produces a valid result, subsequent stages may be skipped to minimize latency and optimize performance.

In an embodiment corresponding to the first stage of extraction, the system may analyze the HTML content of an email for tables containing a column header matching variants of “quant” or “qty,” indicating a potential quantity column. Candidate tables must include at least two data rows. The algorithm may scan each table in sequence and searches for part-number columns by matching headers against a curated list including “item number,” “pn,” “part no,” “part number,” “part/assy number,” “part #,” and “part id.” This list may be derived from an empirical review of over one thousand RFQ samples. Once a part-number column is detected, related columns such as “revision,” “rev,” “description,” “desc,” or “title” may be identified using robust string matching that tolerates variations in case, whitespace, and punctuation. The extracted table content may then be transformed into structured quote items containing all relevant metadata fields.

In an embodiment corresponding to the second stage, the algorithm may extend the structured-table approach by invoking a large language model when header ambiguity prevents deterministic matching. For example, a column labeled “Part Name” may inconsistently contain either descriptive text or actual part identifiers. The large language model, implemented as the open-source Google Text-to-Text Transfer Transformer (T5) with approximately 11 billion parameters operating at 4-bit precision, may be prompted to infer which column most likely corresponds to part numbers. The model can also interpret specialized variants such as “OEM P/N” or “GE Part Number.” If the large language model produces a valid mapping, the table is processed and parsed accordingly. Otherwise, the system may continue to the third stage for unstructured-text interpretation.

In an embodiment corresponding to the third stage, if no valid structured data can be extracted, the email body and headers may be converted into a serialized plain-text representation. Low-value information such as URLs and confidentiality footers is removed, and the text is truncated to approximately 2,048 tokens to ensure efficient inference. The large language model may then be prompted to extract part numbers and corresponding requested quantities directly from the narrative text. Following inference, a post-processing routine validates and sanitizes all outputs. Each extracted item may include a unique part number, trimmed of whitespace and extraneous punctuation, with a valid character length between four and forty. Quantity values may be required to be valid integers, and numeric ranges may be expanded or simplified based on predefined heuristics. For instance, “5-8” may be expanded to include 5, 6, 7, and 8, while “1-10” may be simplified to 1 and 10. Each extracted part number must be verified as present in the input text to eliminate hallucinated values and mitigate any risk of fabricated or sensitive data leakage. In an embodiment, the large language model may operate in inference-only mode using the PyTorch framework on GPU hardware, without fine-tuning or parameter persistence between invocations. This configuration may ensure that the model maintains no memory of prior inputs and that all inference sessions remain stateless. This design, combined with controlled pre- and post-processing, provides operational efficiency and strict data isolation during AI-assisted quote setup, ensuring compliance and trustworthiness across all user interactions.

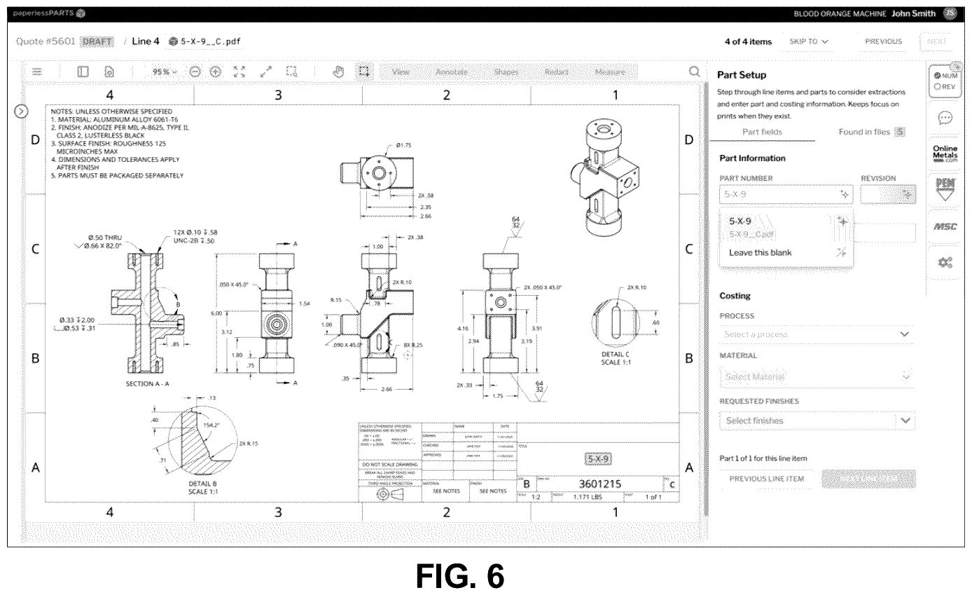

In an embodiment, FIG. 6 illustrates an AI-assisted part metadata setup workflow. When creating a new part record, a user may upload a PDF or other file format containing an engineering drawing and may additionally input key identifying information such as part number, revision, and description. Using the metadata extraction techniques described herein, the system can automatically identify and extract relevant fields from the drawing or from associated filenames, thereby assisting the user during part setup. One embodiment of this assistance includes an experimental feature referred to as “Material Suggestion.” The system maintains a hierarchical database of materials commonly used in manufacturing, organized by material class, family, and specific material name. For example, a typical material entry may include a class of “metal,” a family of “aluminum,” and a material name of “Aluminum 6061.” To infer the likely material family associated with a particular drawing, the system employs Bag-of-Words (BoW) classifiers trained on large corpora of engineering documents. Each BoW classifier may be trained to detect the presence of textual patterns that statistically correlate with specific material families, such as aluminum, stainless steel, or brass. Training data may be drawn from a dataset of over 100,000 engineering PDFs. For each classifier, a vocabulary may be constructed by identifying words that occur in at least 0.1% but fewer than 25% of documents, thereby excluding both extremely rare and overly common terms. The vocabulary may then be reduced to approximately the 20,000 most informative words, which minimizes the risk of embedding sensitive information in the model. Each classifier may be trained as a binary gradient-boosted tree (GBT) model that outputs the probability that a given document belongs to its respective material family. During inference, the system may vectorize the text content of a new drawing and evaluate it against all trained classifiers. If exactly one classifier produces a probability above a predetermined threshold, that material family is returned as the inferred classification. Otherwise, no prediction may be made, and the system may prompt the user to manually specify the material. In addition to metadata extraction, the system can assist in the creation of model-based definitions (MBD) or product manufacturing information (PMI) files, such as those formatted according to the open STEP242 standard. In an example workflow, AI-based callout detection and extraction techniques may identify all annotations on a drawing that could influence manufacturing strategy or runtime. For instance, in CNC milling or additive manufacturing, callouts describing tolerances, hole features, threads, or weld specifications can be automatically linked to corresponding geometric entities in a 3D CAD model. The resulting MBD file may consolidate both 2D and 3D data in a unified context, which can then be transmitted using an application programming interface (API) to a computer-aided manufacturing (CAM) system. This integration may enable automated toolpath generation and other manufacturing preparation tasks, thereby extending the automation capabilities of the digital thread.

In an embodiment, additional background on the artificial intelligence and machine learning techniques employed across the system may be provided to illustrate how these methods support AI-assisted document understanding and classification. The Bag-of-Words (BoW) method is a foundational natural language processing (NLP) technique that converts textual documents into numerical feature vectors suitable for use in machine-learning models. The process begins by creating a vocabulary in which each unique and statistically relevant word is assigned an index. Words that are excessively common, such as stop words (“and,” “the”), or too rare to provide predictive value are excluded. Once the vocabulary is established, each document may be transformed into a vector or row within a matrix, where each column corresponds to a vocabulary term and each cell contains a value indicating the frequency or presence of that term within the document. This representation may omit word order and syntactic relationships, resulting in a loss of linguistic context but yielding a sparse, high-dimensional feature space that is efficient for statistical modeling. In an embodiment, various classification algorithms may then be trained on this matrix to distinguish between document categories. For example, a binary classifier may be trained to predict whether a document describes a part made of aluminum (class 1) or not (class 0). The classifier may assign a learned weight to each word in the vocabulary, summing the weighted values to produce a score for each document. If the score exceeds a threshold, the document is classified as belonging to the target class. The resulting trained model therefore captures generalized word associations rather than document-specific content, preserving both efficiency and privacy. In more advanced implementations, the system may employ Gradient Boosted Trees (GBT) and Bidirectional Long Short-Term Memory (BiLSTM) networks. Gradient Boosted Trees combine multiple decision trees, each learning residual errors from the previous iteration, to model nonlinear relationships between features. This may allow the system to capture subtle co-occurrence patterns in text—for instance, recognizing that the presence of both “tool” and “steel” together is more predictive of a particular material family than either word alone. Meanwhile, Bidirectional Long Short-Term Memory networks process sequences of tokens from both directions to capture contextual dependencies within strings, such as filenames or material specifications. These networks, built upon multi-layer artificial neural network (ANN) architectures, adjust connection weights during training to optimize classification performance. Although deep learning models may not inherently provide explainability, they offer rapid inference once trained, making them particularly effective for metadata parsing, filename segmentation, and material inference at scale.

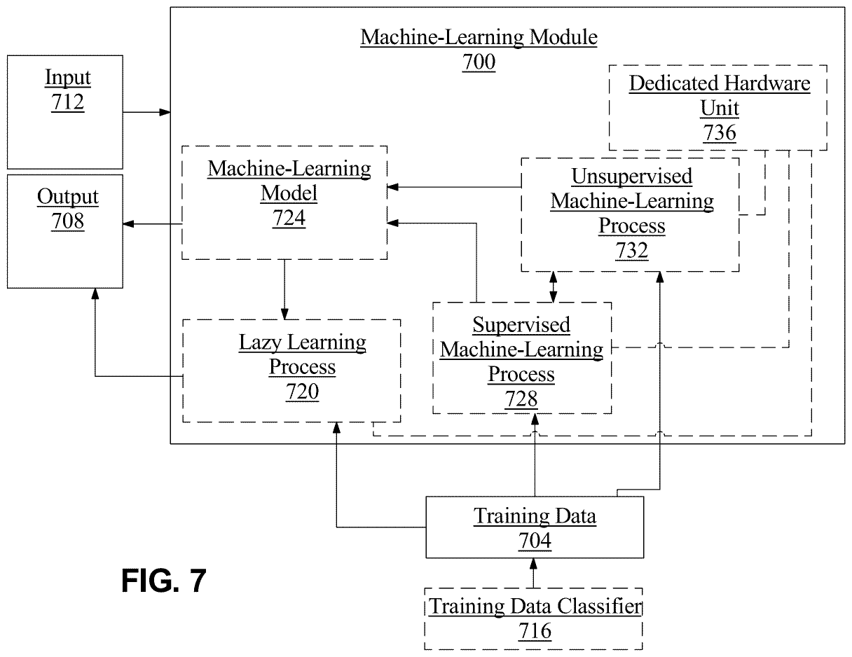

Referring now to FIG. 7, an exemplary embodiment of a machine-learning module 700 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 704 to generate an algorithm instantiated in hardware or software logic, data structures, and/or functions that will be performed by a computing device/module to produce outputs 708 given data provided as inputs 712; this is in contrast to a non-machine learning software program where the commands to be executed are determined in advance by a user and written in a programming language.

Still referring to FIG. 7, “training data,” as used herein, is data containing correlations that a machine-learning process may use to model relationships between two or more categories of data elements. For instance, and without limitation, training data 704 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 704 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations; correlations may indicate causative and/or predictive links between categories of data elements, which may be modeled as relationships such as mathematical relationships by machine-learning processes as described in further detail below. Training data 704 may be formatted and/or organized by categories of data elements, for instance by associating data elements with one or more descriptors corresponding to categories of data elements. As a non-limiting example, training data 704 may include data entered in standardized forms by persons or processes, such that entry of a given data element in a given field in a form may be mapped to one or more descriptors of categories. Elements in training data 704 may be linked to descriptors of categories by tags, tokens, or other data elements; for instance, and without limitation, training data 704 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 7, training data 704 may include one or more elements that are not categorized; that is, training data 704 may not be formatted or contain descriptors for some elements of data. Machine-learning algorithms and/or other processes may sort training data 704 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 704 to be made applicable for two or more distinct machine-learning algorithms as described in further detail below. Training data 704 used by machine-learning module 700 may correlate any input data as described in this disclosure to any output data as described in this disclosure. As a non-limiting illustrative example, input data may include unstructured engineering drawings, PDF-based technical manuals, and mixed-format design specifications containing textual content and graphical symbols, while output data may include structured metadata fields such as document title, revision number, author identifier, material specification, or dimensional tolerance extracted from those artifacts. In another example, the input data may include feature embeddings derived from rasterized symbols or optical character recognition (OCR) outputs, and the corresponding output data may include validated schema-aligned metadata fields representing the inferred relationships or contextual attributes of those extracted features.

Further referring to FIG. 7, training data may be filtered, sorted, and/or selected using one or more supervised and/or unsupervised machine-learning processes and/or models as described in further detail below; such models may include without limitation a training data classifier 716. Training data classifier 716 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 700 may generate a classifier using a classification algorithm, defined as a processes whereby a computing device and/or any module and/or component operating thereon derives a classifier from training data 704. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 716 may classify elements of training data to specific categories of technical artifacts or subpopulations thereof, such as architectural blueprints, electrical schematics, and mechanical assembly drawings; or to metadata extraction contexts such as material specifications, tolerance annotations, or revision block entries. In another embodiment, training data classifier 716 may classify feature representations by privacy sensitivity level, identifying whether a given embedding corresponds to controlled unclassified information (CUI), proprietary design details, or publicly shareable specifications. In some embodiments, the classifier may also categorize data by representation modality, distinguishing between feature instances derived from rasterized text, vector-encoded symbols, or hybrid mixed-content documents. The resulting classifications may be used to route subsets of training data to specialized downstream models, for example, one model optimized for textual feature alignment and another for symbol recognition, ensuring that each model receives data most relevant to its trained domain

Still referring to FIG. 7, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 7, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 7, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where ai is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 7, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 7, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 7, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 7, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 7, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 7, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 7, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 7, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{n e w} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{n e w} = \frac{X - {X}_{m e a n}}{{X}_{max} - {X}_{min}}$$

Feature scaling may include standardization, where a difference between X and Xₘₑₐₙ is divided by a standard deviation σ of a set or subset of values:

$${X}_{n e w} = \frac{X - {X}_{m e a n}}{σ} .$$

Scaling may be performed using a median value of a set or subset X_{median} and/or interquartile range (IQR), which represents the difference between the 25^{th} percentile value and the 50^{th} percentile value (or closest values thereto by a rounding protocol), such as:

$${X}_{n e w} = \frac{X - {X}_{m e d i a n}}{IQR} .$$

Persons skilled in the art, upon reviewing the entirety of this disclosure, will be aware of various alternative or additional approaches that may be used for feature scaling.

Further referring to FIG. 7, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 7, machine-learning module 700 may be configured to perform a lazy-learning process 720 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 704. Heuristic may include selecting some number of highest-ranking associations and/or training data 704 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 7, machine-learning processes as described in this disclosure may be used to generate machine-learning models 724. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 724 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 724 may be generated by creating an artificial neural network, such as a convolutional neural network comprising an input layer of nodes, one or more intermediate layers, and an output layer of nodes. Connections between nodes may be created via the process of “training” the network, in which elements from a training data 704 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, machine-learning algorithms may include at least a supervised machine-learning process 728. At least a supervised machine-learning process 728, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described above as inputs, outputs as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 704. Persons skilled in the art, upon reviewing the entirety of this disclosure, will be aware of various possible variations of at least a supervised machine-learning process 728 that may be used to determine relation between inputs and outputs. Supervised machine-learning processes may include classification algorithms as defined above.

With further reference to FIG. 7, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Continuing to refer to FIG. 7, evaluation of error function and/or other comparison results may include comparison of each of error function and/or other comparison results to a maximum single error threshold; in other words, a criterion of evaluation may include performing iterative retraining if any single comparison and/or error function output exceeds maximum single error threshold or if a count of single comparison and/or error function outputs exceeding single error threshold exceeds a threshold number and/or proportion of overall error function and/or other comparison results. Alternatively or additionally, evaluation of error function and/or other comparison results may include comparison of an aggregated plurality of error function and/or other comparison results to an aggregate error threshold; in other words, a criterion of evaluation may include performing iterative retraining if a result of averaging or otherwise aggregating a plurality such as some or all evaluated function and/or other comparison results exceeds aggregate error threshold. Aggregation may be performed in any manner of aggregation described in this disclosure and/or any combination thereof. Criteria for evaluations may be evaluated separately such that failing any one criterion causes iterative retraining; alternatively or additionally evaluation results may be combined according to one or more logical or other rules.

As a non-limiting, illustrative example, and still referring to FIG. 7, where outputs to be compared by error function are numerical values, error function may include subtraction of one from the other to derive an absolute value and/or mean squared error. Where outputs and/or training examples are represented as a binary classification, an error function may include a hinge loss function, sigmoid cross entropy loss function, weighted cross entropy loss function, or the like. Where output and/or exemplary output in a training set is a classification to three or more values, error function may include a softmax cross entropy loss function, a sparse cross entropy loss function, a Kullback-Leibler divergence loss function, or the like. Where both retaining and training with include supervised training, retraining may use a different error function, different weight update functions and/or parameters, or the like than in the training stage. For instance, and without limitation, when a previous iterative retraining process included training using examples from until a first convergence threshold and/or epsilon value and/or neighborhood is met, a subsequent iterative retraining process may include a lower convergence threshold, a smaller value of epsilon, or the like. Iterative retraining may include using one or more examples that were not used in any previous training and/or retraining process; for instance, where convergence was initially and/or previously achieved using a first subset of examples a subsequent retraining process may use examples from a second subset of examples, which may be wholly disjoint from first subset and/or have one or more elements that are not found in first subset.

Still referring to FIG. 7, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 7, machine learning processes may include at least an unsupervised machine-learning processes 732. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 732 may not require a response variable; unsupervised processes 732 may be used to find interesting patterns and/or inferences between variables, to determine a degree of correlation between two or more variables, or the like.

Still referring to FIG. 7, machine-learning module 700 may be designed and configured to create a machine-learning model 724 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 7, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including, without limitation, support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 7, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 7, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 7, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 7, one or more processes or algorithms described above may be performed by at least a dedicated hardware unit 736. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 736 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 736 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 736 to perform one or more operations described herein, such as evaluation of model and/or algorithm outputs, one-time or iterative updates to parameters, coefficients, weights, and/or biases, and/or any other operations such as vector and/or matrix operations as described in this disclosure.

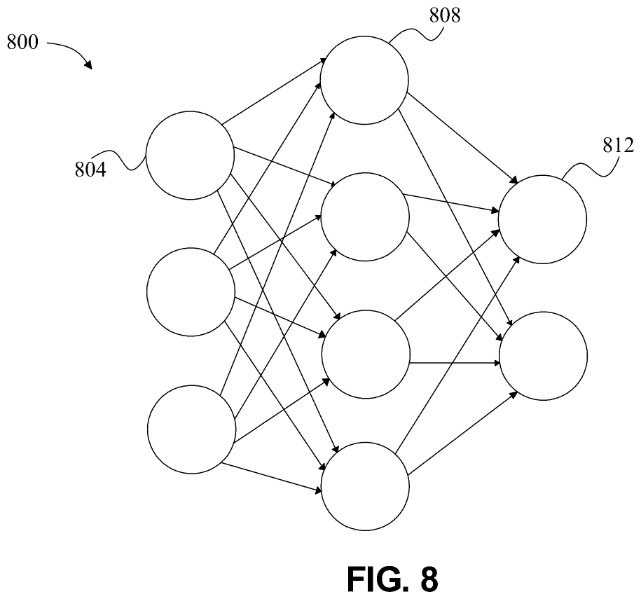

Referring now to FIG. 8, an exemplary embodiment of neural network 800 is illustrated. A neural network 800 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 804, one or more intermediate layers 808, and an output layer of nodes 812. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

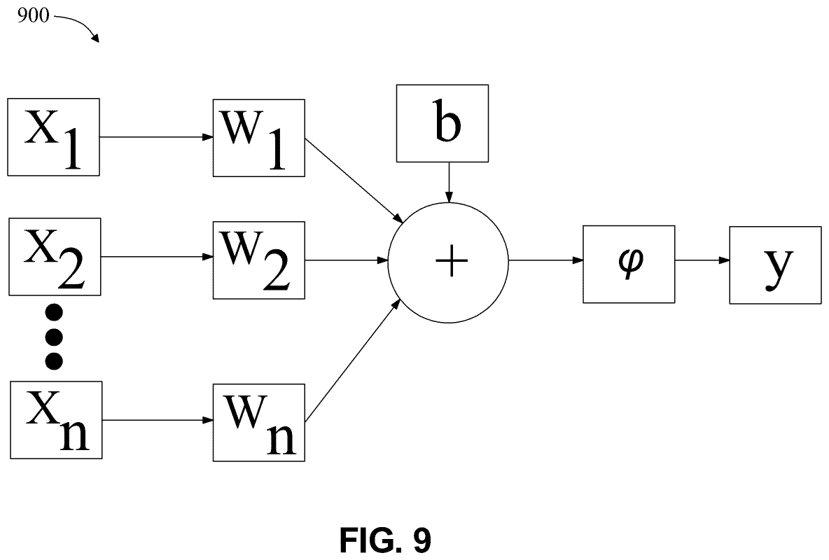

Referring now to FIG. 9, an exemplary embodiment of a node 900 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as f(x)=tan h²(x), a rectified linear unit function such as f(x)=max(0,x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{Σ}_{i} {x}_{i}}$$

where the inputs to an instant layer are xᵢ, a swish function such as f(x)=x*sigmoid(x), a Gaussian error linear unit function such as f(x)=a(1+tan h(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{n e w} = {w}_{o l d} - α \frac{d J}{d w}$$

where w_{new} is the updated weight value, w_{old} is the previous weight value, α is a parameter to set the learning rate, and dJ/dw is the partial derivative of with respect to weight w.

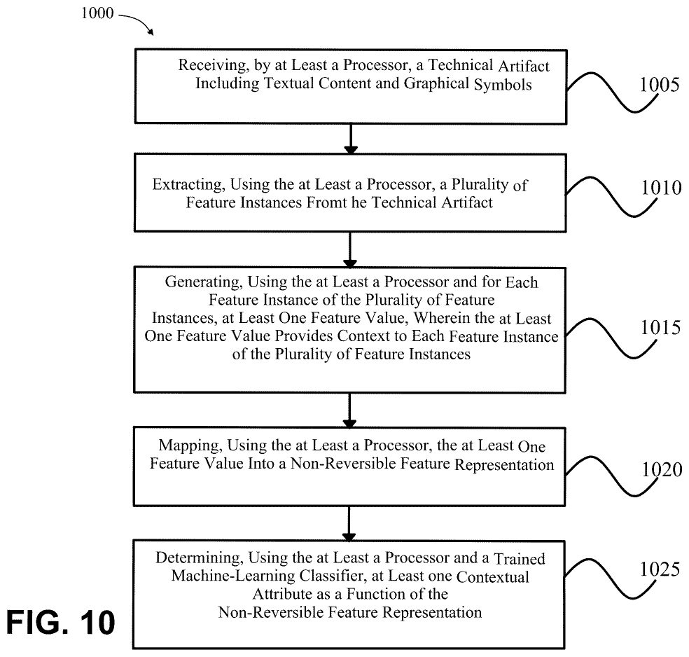

Referring now to FIG. 10, a flow diagram of an exemplary method 1000 of privacy-preserving metadata extraction from technical artifacts using machine-learning is illustrated. Method 1000 may include a step 1005 of receiving, by at least a processor, a technical artifact comprising textual content and graphical symbols. This may be implemented, without limitation, as referenced in FIGS. 1-9.

In continued reference to FIG. 10, method 1000 may include a step 1010 of extracting, using the at least a processor, a plurality of feature instances from the technical artifact. This may be implemented, without limitation, as described herein and referenced in FIGS. 1-9.

With further reference to FIG. 10, method 1000 may include a step 1015 of generating, using the at least a processor and for each feature instance of the feature instances, at least one feature value, wherein the at least one feature value provides context to each feature instance of the plurality of feature instances. This may be implemented, without limitation, as described herein and referenced in FIGS. 1-9.

Still referring to FIG. 10, method 1000 may include a step 1020 of mapping, using the at least a processor, the at least one feature value into a non-reversible feature representation. This may be implemented, without limitation, as described herein and referenced in FIGS. 1-9.

With continued reference to FIG. 10, method 1000 may include a step 1025 of determining, using the at least a processor and a trained machine-learning classifier, at least one contextual attribute as a function of the non-reversible feature representation. In an embodiment, mapping the at least one feature value into the non-reversible feature representation may include embedding the at least one feature value into a vector space constrained by a dimensionality-reduction function, wherein the dimensionality-reduction function omits one or more reconstructive components of the textual content and graphical symbols of the technical artifact. In an embodiment, the trained machine-learning classifier may have been trained using feature representations derived from technical artifacts containing controlled unclassified information (CUI). In an embodiment, determining the at least one contextual attribute may include: initializing parameters of the trained machine-learning classifier from a fixed weight store at an initialization of each inference operation, processing, using the trained machine-learning classifier, the non-reversible feature representation to generate the at least one contextual attribute, and deallocating intermediate data following generation of the at least one contextual attribute. In an embodiment, the trained machine-learning classifier may include a plurality of classifiers, wherein each classifier of the plurality of classifiers has been trained on a distinct subset of feature values. In an embodiment, determining the at least one contextual attribute may include: generating, using the plurality of classifiers, a plurality of candidate contextual attributes, wherein each candidate contextual attribute is associated with a corresponding confidence score and selecting, as the at least one contextual attribute, a candidate contextual attribute of the plurality of candidate contextual attributes as a function of the corresponding confidence score. This may be implemented, without limitation, as described herein and referenced in FIGS. 1-9.

In further reference to FIG. 10, method 1000 may include evaluating, using the at least a processor, the non-reversible feature representation using a reconstruction detector, wherein evaluating the non-reversible feature representation may include: generating, using a reconstruction model, a reconstructed output corresponding to one or more of the textual content and the graphical symbols of the technical artifact, computing a reconstruction score as a function of comparing the reconstructed output to the technical artifact, and determining satisfaction of a privacy criterion as a function of the reconstruction score and a predetermined reconstruction threshold. In an embodiment, method 1000 may further include initiating, using the at least a processor, a feature-remapping procedure as a function of the reconstruction score and the predetermined reconstruction threshold. This may be implemented, without limitation, as described herein and referenced in FIGS. 1-9.

Still referring to FIG. 10, method 1000 may include applying, using the at least a processor, a hallucination-mitigation routine to the at least one contextual attribute, wherein applying the hallucination-mitigation routine to the at least one contextual attribute includes: comparing the at least one contextual attribute to the at least one feature value extracted from the technical artifact and adjusting the at least one contextual attribute as a function of a consistency score and a predetermined hallucination threshold, wherein the consistency score is calculated as a function of comparing the at least one contextual attribute to the at least one feature value. This may be implemented, without limitation, as described herein and referenced in FIGS. 1-9.

In continued reference to FIG. 10, method 1000 may include validating, using the at least a processor, the at least one contextual attribute against a predefined schema. Further, method 1000 may include converting, using the at least a processor, one or more of data types and units as a function of validating the at least one contextual attribute against the predefined schema. Further still, method 1000 may include reformatting, using the at least a processor, the at least one contextual attribute for integration into a downstream workflow. This may be implemented, without limitation, as described herein and referenced in FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

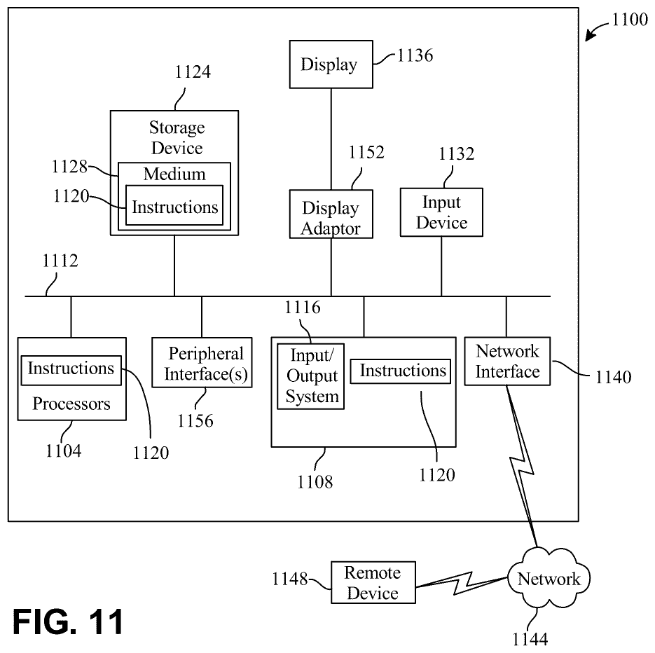

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof. Memory 1108 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In some embodiments, storage device 1124 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display 1136. Examples of a display device include, but are not limited to, a liquid crystal display (LCD), a cathode ray tube (CRT), a plasma display, a light emitting diode (LED) display, and any combinations thereof. Display adapter 1152 and display 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

Further referring to FIG. 11, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 11, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 11, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 1100, processor 1104, and memory 1108 may be virtualized; that is, a virtual machine and/or container may interact directly with such computing system 1100, processor 1104, and/or memory 1108, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 1104 comprises a plurality of processors and/or processor cores, virtualization may, in some cases, simulate or emulate a single (virtual) processor whose functions are allocated to one or more of the plurality of processors and/or processor cores. In this case, while processor 1104 may be said to be virtualized, the processor 1104, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention. Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for privacy-preserving contextual attribute extraction from technical artifacts using machine-learning, the system comprising:
at least a processor; and
a memory communicatively connected to the at least a processor, wherein the memory contains instructions configuring the at least a processor to:
receive a technical artifact comprising textual content and graphical symbols;
extract a plurality of feature instances from the technical artifact;
generate, for each feature instance of the plurality of feature instances, at least one feature value, wherein the at least one feature value provides context to each feature instance of the plurality of feature instances;
map the at least one feature value into a non-reversible feature representation; and
determine, using a trained machine-learning classifier, at least one contextual attribute as a function of the non-reversible feature representation.

2. The system of claim 1, wherein mapping the at least one feature value into the non-reversible feature representation comprises embedding the at least one feature value into a vector space constrained by a dimensionality-reduction function, wherein the dimensionality-reduction function omits one or more reconstructive components of the textual content and graphical symbols of the technical artifact.

3. The system of claim 1, wherein the at least a processor is further configured to evaluate the non-reversible feature representation using a reconstruction detector, wherein evaluating the non-reversible feature representation comprises:
generating, using a reconstruction model, a reconstructed output corresponding to one or more of the textual content and the graphical symbols of the technical artifact;
computing a reconstruction score as a function of comparing the reconstructed output to the technical artifact; and
determining satisfaction of a privacy criterion as a function of the reconstruction score and a predetermined reconstruction threshold.

4. The system of claim 3, wherein the at least a processor is further configured to initiate a feature-remapping procedure as a function of the reconstruction score and the predetermined reconstruction threshold.

5. The system of claim 1, wherein the trained machine-learning classifier has been trained using feature representations derived from technical artifacts containing controlled unclassified information (CUI).

6. The system of claim 1, wherein determining the at least one contextual attribute comprises:
initializing parameters of the trained machine-learning classifier from a fixed weight store at an initialization of each inference operation;
processing, using the trained machine-learning classifier, the non-reversible feature representation to generate the at least one contextual attribute; and
deallocating intermediate data following generation of the at least one contextual attribute.

7. The system of claim 1, wherein the trained machine-learning classifier comprises a plurality of classifiers, wherein each classifier of the plurality of classifiers has been trained on a distinct subset of feature values.

8. The system of claim 7, wherein determining the at least one contextual attribute comprises:
generating, using the plurality of classifiers, a plurality of candidate contextual attributes, wherein each candidate contextual attribute is associated with a corresponding confidence score; and
selecting, as the at least one contextual attribute, a candidate contextual attribute of the plurality of candidate contextual attributes as a function of the corresponding confidence score.

9. The system of claim 1, wherein the at least a processor is further configured to apply a hallucination-mitigation routine to the at least one contextual attribute, wherein applying the hallucination-mitigation routine to the at least one contextual attribute comprises:
comparing the at least one contextual attribute to the at least one feature value extracted from the technical artifact; and
adjusting the at least one contextual attribute as a function of a consistency score and a predetermined hallucination threshold, wherein the consistency score is calculated as a function of comparing the at least one contextual attribute to the at least one feature value.

10. The system of claim 1, wherein the at least a processor is further configured to:
validate the at least one contextual attribute against a predefined schema;
convert one or more of data types and units as a function of validating the at least one contextual attribute against the predefined schema; and
reformat the at least one contextual attribute for integration into a downstream workflow.

11. A method of privacy-preserving metadata extraction from technical artifacts using machine-learning, the method comprising:
receiving, by at least a processor, a technical artifact comprising textual content and graphical symbols;
extracting, using the at least a processor, a plurality of feature instances from the technical artifact;
generating, using the at least a processor and for each feature instance of the plurality of feature instances, at least one feature value, wherein the at least one feature value provides context to each feature instance of the plurality of feature instances;
mapping, using the at least a processor, the at least one feature value into a non-reversible feature representation; and
determining, using the at least a processor and a trained machine-learning classifier, at least one contextual attribute as a function of the non-reversible feature representation.

12. The method of claim 11, wherein mapping the at least one feature value into the non-reversible feature representation comprises embedding the at least one feature value into a vector space constrained by a dimensionality-reduction function, wherein the dimensionality-reduction function omits one or more reconstructive components of the textual content and graphical symbols of the technical artifact.

13. The method of claim 11, further comprising evaluating, using the at least a processor, the non-reversible feature representation using a reconstruction detector, wherein evaluating the non-reversible feature representation comprises:
generating, using a reconstruction model, a reconstructed output corresponding to one or more of the textual content and the graphical symbols of the technical artifact;
computing a reconstruction score as a function of comparing the reconstructed output to the technical artifact; and
determining satisfaction of a privacy criterion as a function of the reconstruction score and a predetermined reconstruction threshold.

14. The method of claim 13, further comprising initiating, using the at least a processor, a feature-remapping procedure as a function of the reconstruction score and the predetermined reconstruction threshold.

15. The method of claim 11, wherein the trained machine-learning classifier has been trained using feature representations derived from technical artifacts containing controlled unclassified information (CUI).

16. The method of claim 11, wherein determining the at least one contextual attribute comprises:
initializing parameters of the trained machine-learning classifier from a fixed weight store at an initialization of each inference operation;
processing, using the trained machine-learning classifier, the non-reversible feature representation to generate the at least one contextual attribute; and
deallocating intermediate data following generation of the at least one contextual attribute.

17. The method of claim 11, wherein the trained machine-learning classifier comprises a plurality of classifiers, wherein each classifier of the plurality of classifiers has been trained on a distinct subset of feature values.

18. The method of claim 17, wherein determining the at least one contextual attribute comprises:
generating, using the plurality of classifiers, a plurality of candidate contextual attributes, wherein each candidate contextual attribute is associated with a corresponding confidence score; and
selecting, as the at least one contextual attribute, a candidate contextual attribute of the plurality of candidate contextual attributes as a function of the corresponding confidence score.

19. The method of claim 11, further comprising applying, using the at least a processor, a hallucination-mitigation routine to the at least one contextual attribute, wherein applying the hallucination-mitigation routine to the at least one contextual attribute comprises:
comparing the at least one contextual attribute to the at least one feature value extracted from the technical artifact; and
adjusting the at least one contextual attribute as a function of a consistency score and a predetermined hallucination threshold, wherein the consistency score is calculated as a function of comparing the at least one contextual attribute to the at least one feature value.

20. The method of claim 11, further comprising:
validating, using the at least a processor, the at least one contextual attribute against a predefined schema;
converting, using the at least a processor, one or more of data types and units as a function of validating the at least one contextual attribute against the predefined schema; and
reformatting, using the at least a processor, the at least one contextual attribute for integration into a downstream workflow.
